(19) United States
(12) Patent Application Publication
(10) Pub. No.: US 2018/0240107 A1
(43) Pub. Date: Aug. 23, 2018

(54) SYSTEMS AND METHODS FOR PERSONAL IDENTIFICATION AND VERIFICATION

(71) Applicant: BLACK GOLD COIN, INC., Las Vegas, NV (US)

(72) Inventor: Marcus Andrade, Fernley, NV (US)

(73) Assignee: BLACK GOLD COIN, INC., Las Vegas, NV (US)

(21) Appl. No.: 15/945,097

(22) Filed: Apr. 4, 2018

Related U.S. Application Data
(63) Continuation-in-part of application No. 14/940,142, filed on Nov. 12, 2015.

(30) Foreign Application Priority Data
Mar. 27, 2015 (EP) 15161502

(51) Int. Cl. G06Q 20/36; G06Q 20/06; G06Q 20/40

(52) U.S. Cl. CPC G06Q 20/36; G06Q 20/4016; G06Q 20/065

(57) ABSTRACT

A personal/client identification and verification process, pseudonymous system and transaction network for monitoring and restricting transactions of cryptography-based electronic money. In one embodiment, there is a legal identity-linked credential authentication protocol for providing a practical solution for issues related to cryptocurrency theft, KYC and AML, while maintaining user privacy. In other embodiments, there are mechanisms to monitor transactions for suspicious activity. A determination of AML risk and/or other risks of running afoul of financial crimes may be made, e.g., in response to a transaction, and the determination may be expressed as a risk score. In some embodiments, transactions may be held and/or reversed. In further embodiments, a client wallet within the transaction network may support multiple types of cryptocurrency and may detect transactions from or to wallets outside of the transaction network, and optionally provide an alert and/or the system may take other responsive action.

### CROSS REFERENCE TO RELATED APPLICATIONS

This application claims the priority benefit of U.S. patent application Ser. No. 14/940,142, filed Nov. 12, 2015, which claims priority from European Patent Application No. EP15161502.8 filed on Mar. 27, 2015 and entitled “A System and a Method for Personal Identification and Verification,” both of which are incorporated herein by reference.

### FIELD OF THE DISCLOSURE

The present invention relates to a system and method for personal identification and verification. In particular the present invention relates to personal/client identification and verification process, pseudonymous system and transaction network for monitoring and restricting transactions of cryptography-based electronic money—legal identity-linked credential authentication protocol.

### BACKGROUND

Prior art defines digital currency or digital money. It is an internet based medium of exchange (i.e., distinct from physical, such as banknotes and coins) that exhibits properties similar to physical currencies, however, allows for instantaneous transactions and borderless transfer-of-ownership.

Both virtual currencies and cryptocurrencies are types of digital currencies, but the converse is incorrect. Like traditional money these currencies may be used to buy physical goods and services. Digital currencies such as bitcoin are known as “decentralized digital currencies,” meaning that there is no central point of control over the money supply. (see Wikipedia)

Bitcoin is cryptographic-based electronic money (CBEM), which was invented in 2008. Bitcoin is not only virtual money, but also a payment system composed of a decentralized peer-to-peer transaction network for recording and verifying the money transactions.

Each bitcoin owner has been assigned a unique bitcoin address or addresses and has software called a client wallet. Bitcoins (i.e., units of cryptocurrency) are not stored in individual owners' client wallets, but their ownerships are recorded in a public ledger of all bitcoin transactions, i.e., blockchain, by using bitcoin addresses of the owners. A bitcoin address is a 160-bit hash of the public portion of a public/private Elliptic Curve Digital Signature Algorithm (ECDSA) key pair. The private key for each bitcoin address is stored in the client wallet of the address owner.

Moreover, all client wallets are connected with each other through the Internet and form nodes of a transaction network to relay and verify the transactions. Using public/private-key cryptography, one can “sign” (i.e., use his/her private key) to send an amount of bitcoins recorded at his/her bitcoin address to another bitcoin address. Typically, when the transaction is signed by a private key. Anyone in the transaction network can verify whether the signature is valid. In addition, anyone in the transaction network can review the ledger to determine if the transaction is valid, i.e., if the party transferring bitcoins in fact had that many bitcoins to transfer.

Since 2008, there have been different cryptographic-based electronic currencies being created and collectively called alternative cryptocurrencies. Among them, some of these other bitcoins use different cryptographic hash algorithms (e.g., Litecoin) and/or having additional functions (e.g., CinniCoin), while some are created using different signature technologies (e.g., CryptoNote).

By design, the original bitcoin is pseudonymous, while all alternative cryptocurrencies are either pseudonymous or anonymous. For anonymous cryptocurrency, it can be easily applied to money laundering activities because all senders and receivers in money transactions are not traceable. For pseudonymous cryptocurrency, an academic study (Meiklejohn S, et al. University of California, San Diego, 2013) showed that evidence of interactions between institutes could be identified by analyzing the pattern of involvements of bitcoin addresses in empirical purchasing of goods and services.

This approach may be able to identify illegal activities at institution level, but still not able to narrow down to a single person level. A recent academic study (Koshy P, et al. Pennsylvania State University, 2014) has shown that it is possible to map a bitcoin address to an IP address. However, this approach is only applicable to less than 10% of the bitcoin addresses. Therefore, it is generally believed that bitcoin and other alternative cryptocurrencies can be used for illegal activities such as money laundering (Bryans D, Indiana Law Journal, 89 (1):441, 2014).

The pseudonymous/anonymous property also makes bitcoin and alternative cryptocurrencies become attractive targets for hackers and thieves. For example, in February 2014, the Mt. Gox company, which was the world largest bitcoin exchange company at that time, entered bankruptcy proceedings because the company was being hacked continuously, resulting in loss of 850,000 bitcoins (worth about US $480 million).

In January 2015, the Slovenian bitcoin exchange Bitstamp, which was the world's third largest bitcoin exchange at that time, was hacked, and less than 19,000 BTC (worth about US $5 million) was stolen. Although the hackers/thieves must transfer the stolen bitcoins to their bitcoin addresses, the identities of most of these hackers and thieves remain unknown.

Therefore, there are needed Anti-Theft Solutions for bitcoin. The ownerships of bitcoins are being protected by private keys, which are stored in users' wallets. Private keys can be created from a passphrase. For example, Brainwallet is a website that provides a tool to generate a bitcoin address and its private key from the sha256 of a passphrase. Using a password dictionary, one could analyze the bitcoin blockchain and search for active bitcoin addresses created from typical passwords, and steal the bitcoins from these addresses by deriving and using the corresponding private keys.

One simple anti-theft solution is to avoid using bitcoin addresses generated from typical passphrases. For other bitcoin addresses, hackers can hack the computers or servers of bitcoin owners to look for files containing the private key records. Once these files are discovered, bitcoins stored at the corresponding addresses can be easily transferred to another address. The simple solution for this is to keep such files in a cold storage (i.e., a device which is not connected to the Internet), or even not to create such files.

Another way to steal bitcoins is to steal the main wallet data file (i.e., wallet.dat file) in a bitcoin wallet, which is installed in a computer or server connected to the Internet. Robert Lipovsky (2013) reported an online banking trojan that can steal the wallet.dat files. Private keys are stored in the wallet.dat files and are protected with passphrases. Once the main wallet data file is stolen, the protection passphrase can be cracked by dictionary-based guessing, permutations of dictionary words or pure brute force.

One example of solutions for such stolen bitcoin wallets is presented in a patent application publication of CN103927656 (A) entitled “Bitcoin Terminal Wallet with Embedded, Fixed Collecting Address and Bitcoin Payment Method of Bitcoin Terminal Wallet”.

One simple solution, to the above, is to store bitcoins at a multi-signature address, a currency address that requires two private keys for spending the bitcoins. One private key is stored in a computing device (e.g. local computer), while another key is stored in a separate computing device (e.g. smart phone, remote server), creating two-factor authentication for transactions. Such solution is not yet available until the present invention.

Another solution is to make all bitcoin senders and receivers identifiable. The legal identities of the thefts or hackers can then be uncovered from revealing the legal identities of owners of the bitcoin addresses receiving the stolen bitcoins. Such solution is not yet available until the present invention.

Currently Anti-Money Laundering (AML) solutions for bitcoin are highly demandable. For bitcoin service providing companies to meet U.S. (FinCEN) and worldwide regulations in AML, the current approach is a combined use of know-your-customer (KYC) and transaction monitoring. To make this possible, all traders/customers must provide their legal identities and subjected to verification. However, this approach suffers from two major problems. First, this approach is mainly adopted by companies providing legitimate services. Therefore, AML activities involving bitcoins can still happen worldwide. Second, companies usually have their own customer registration and identity verification systems.

This not only leads to redundancy in resources and high business running cost, but also creates annoyance for bitcoin users. Being an honest bitcoin user, one may need to repeatedly provide identity documents to different bitcoin service providing companies for identity verification before using their services.

On 25 Feb. 2015, Bank of England launched its One Bank Research Agenda—an ambitious and wide-ranging framework to transform the way research is done at the Bank. According to this discussion paper, Bank of England is investigating whether central banks should themselves make use of the bitcoin's blockchain technology to issue their own digital currencies. Bank of England has stated that issues related to KYC and AML have to be addressed and should investigate how digital identity management could be achieved while balancing privacy considerations.

Taking into account the foregoing, it would be advantageous to design a personal/client identification and verification process, pseudonymous system and transaction network for monitoring and restricting transactions of cryptography-based electronic money, that would obviate at least some of the aforementioned disadvantages.

The present invention—“legal identity-linked credential authentication protocol” is the first protocol providing a practical solution for the issues related to cryptocurrency theft, KYC and AML, while maintaining user privacy.

Last but not least, the present invention can be adopted or modified by the central banks or other financial institutions, in order to issue their own digital currencies that are supported by a ledger payment system, and also regulated by a central governing body. The ledger can be private or open to the public. Such digital currencies can hence inherit advantages of the existing banking system and advantages of cryptography-based electronic money.

### SUMMARY

Embodiments of the invention presented herein may be summarized by the following clauses.
1. A method for personal/client identification and verification for transactions involving cryptography-based electronic money, the method being executed by a computational server (101) comprising at least one computer program functioning as a registration interface (102), and the method being characterized in that it comprises the steps of:
   providing access to one or more potential or existing currency users (103);
   providing a registration interface (102) for one or more potential currency users to register a user account requiring authentication (104);
   requesting the submission of documents for proof of legal identity of a registrant (105);
   verifying the legal identity of the registrant (106);
   rejecting an account creation for registrants failing in legal identity verification (107);
   creating a personal/client account (108) for individual successful registrants (109) with successful verification of legal identity (110);
   allowing a successful registrant (109) to create a credential (111) that comprises an associated authentication (112);
   storing (116) all the submitted information in a client information database (115);
   sending (117) the credential to central approval servers (401); and
   mapping and storing (118) multi-signature currency address(es), credential and legal identity of individual registrants.

The above may further include any one or more of the following:
(i) Authentication may be effected by means of a password protection, two factor authentication or multiple factor authentication;
(ii) a step of encrypting the credentials (114); and/or
(iii) the credential is a digital, electronic or hardware item which can be used as an authentication mechanism to identify oneself. For example, it can be a unique pair of digital codes (e.g., name and password); it can be a unique product key for activating a client wallet software; and it can be a constantly changing token (e.g. a unique 7-digit code) tied to a physical device that is owned by the user, such as a cellphone or a personalized secure key generating device.
2. A method for creating a cryptography-based electronic money (CBEM) (201) and its associated transaction network (202), the method being executed by a network of computer programs functioning as nodes, and the method being characterized in that it comprises the steps of:
   installing a node (203), which can be a stand-alone computer program or a functional module of a client wallet (111), in one or more client computers and/or servers (204);
   connecting all nodes to form relay nodes (205) of a peer-to-peer network through a data transmission network (206);
   controlling the method for creating at least one unit of the CBEM (207); protecting the ownerships of at least one unit of the CBEM by public/private-key cryptography (208);
   recording ownerships of at least one unit of the CBEM into a ledger of all transactions (e.g. blockchain) (209) using the owners' currency addresses (313) (210);
   verifying ownerships of at least one unit of the CBEM (211);
   restricting only valid registered users (109) to generate one or more valid currency addresses (313) to receive at least one unit of the CBEM by verifying the submitted credential (111) with one of the central approval servers (401) (212);
   recording transactions of at least one unit of the CBEM into the ledger (209) (213);
   verifying transactions of at least one unit of the CBEM (214);
   controlling the method for transacting at least one unit of the CBEM (215); incorporating the transaction rules into the programming code of at least one nodes (216);
   restricting at least one transaction approval rule (217), comprising at least one of: requisition of a valid credential (111) from the sender, requisition of one or more approval private keys (406) from one of the central approval servers (401);
   allowing only creation of multi-signature transactions in pay-to-script-hash format or any other compatible format (218);
   allowing only creation of multi-signature transactions each requiring at least two private keys as signatures (219);
   allowing only creation of multi-signature transactions in the presence of a valid credential (111) (220);
   restricting one of these private keys (219) to be an approval private key (406) from one of the central approval servers (221);
   restricting the rest of the private keys (219) to be client private keys (222), which are encrypted and stored in the client wallet(s) (301)(223);
   sending all transaction requests from the client wallets (301) to one of the central approval servers (401) to obtain the approval private key for signing the transactions (224); and
   rejecting all transactions missing any one of the required private keys (219); (225).
3. A method for personal/client identification and verification for transactions involving cryptography-based electronic money, the method being executed by a computer program functioning as a client device of a user, and the method being characterized in that it comprises the steps of:
   installing a computer program of a client device to function as a client wallet (301) in at least one computer or computational server (302);
   serving as one of the relay nodes (205) for relaying information of all CBEM units (e.g., coins) being generated in the transaction network (202) (303); serving as one of the relay nodes (205) for relaying all transaction information in the transaction network (202) (304);
   serving as one of the relay nodes to verify and confirm all transactions that are broadcasted to the transaction network (202) (305);
   generating new coins through contributing to recording any new transaction information into the ledger of all transactions (e.g. the blockchain) (209) (306);
   generating one or more pairs of cryptographic client public key (307) and client private key (308) for receiving and sending coins (309);
   storing the client public-private key pairs (items 307, 308) of one or more currency addresses generated by the currency users (310);
   serving as a client wallet for the currency users to receive and send coins; (311);
   serving as an client wallet to communicate between one of the central approval servers (401) and registered currency users (109) (312);
   only generating (314) currency addresses which are multi-signature addresses (313);
   generating one of more multi-signature addresses (313) from the client public key (307) and the approval public key (405) (315);
   only storing one or more multi-signature addresses (313) in the client wallet (301) for sending and receiving coins (316);
   sending one of more multi-signature addresses (313) to the client information database (401) for storage and mapping to legal identity of the owner of the address(es) (317);
   sending the generated valid multi-signature addresses (313) to the central approval servers (401) for storage (318);
   submitting a credential (111) of a valid registered users (109) to one of the central approval servers for obtaining approval to generate one or more valid currency multi-signature addresses (313) (319);
   submitting a credential (111) of a valid registered users (109) to one of the central approval servers for obtaining approval to create one or more valid transactions (items 218, 219, 220, 221, 223) to send coins to one or more currency addresses (320);
   allowing only creation of transactions that use multi-signature addresses (313) for both sending and receiving the coins (321); and
   recording unspent coins (if there is any) into the blockchain at the currency address from where the coins have just been sent (322).
4. A method for personal/client identification and verification for transactions involving cryptography-based electronic money, the method being executed by a computer program in a computational server functioning as a central approval server (401), and the method being characterized in that it comprises the steps of:
   communicating (407) with a client wallet (301) to generate one or more valid multi-signature currency addresses (313) in the presence of a valid credential;
   providing (408) approval public key (405) to the currency wallet to create one or more multi-signature addresses (313),
   communicating (409) with the client wallet (301) to generate one or more valid transactions (218, 219, 220, 221, 223) to send coins to one or more currency address in the presence of a valid credential;
   providing (410) approval private key (406), which are corresponding to the approval public key (405) used in creation of the multi-signature address (313), to sign transaction input for one or more valid transactions (218, 219, 220, 221, 223);
   providing the most recent private key (411) to sign the whole transaction for one or more valid transactions (412); and
   storing (414) transaction information in a transactions database (413).

The method according to any or all of the above clauses, characterized in any one or more of the following ways:
that the most recent approval private key (411) is the approval private key corresponding to the approval public key (405) used in creation of the multi-signature address (313) or another approval private key;
that the step of storing (414) transaction information in a transactions database (413) includes storing a transaction ID, sender's currency address, receiver's currency address, amount of coins being transacted, transaction time and IP addresses of the sender and the receiver's client wallets;
that the method further has a step of verifying the transaction against one or more transaction criteria (501, 502) at the central approval server (401);
that the one or more transaction criteria (501, 502) include criteria predefined by a central governing body (601) and/or the registrant; and/or
that the method further has a step of tracing legal identities of the sender and receiver by mapping their currency addresses in the transaction database and the client information database when needed.
5. A method for personal/client identification and verification for transactions involving cryptography-based electronic money, the method being executed by a set of computer programs functioning as devices of a central governing body and a client device of a user, the method being characterized in that it comprises the steps of:
   receiving credentials, of a registrant, comprising at least two factor authentication credentials defining a multi-signature;
   verifying legal identity of the registrant;
   creating a personal/client account (108) for an individual successful registrant (109) with successful verification of legal identity (110) whereas the personal/client account facilitates mapping and storing the multi-signature of a currency address and legal identity of individual registrants (118);
   providing a registrant wallet comprising at least one unit of electronic money;
   recording ownerships of the at least one unit of electronic money into a transactions database (413) using the registrants' currency address (313);
   creating a multi-signature transaction, in a pay-to-script-hash format or any other compatible format (218), each requiring at least two private keys as approval signatures (219);
   restricting one of these private keys (219) to be an approval private key (406) from one of central approval servers (221);
   restricting the rest of the private keys (219) to be the registrant's private keys (222), which are stored in the client wallet (301, 223);
   sending the transaction request from the client wallet (301) to at least one of the central approval servers (401) in order to obtain the approval private key for signing the transaction (224); and
   broadcasting the approved transaction messages to all relay nodes in a transaction network (214).
6. A system for personal/client identification and verification for transactions involving cryptography-based electronic money, the system comprising:
   a central approval server (401) configured to execute the method according to clause 7 in order to process client registration requests, client cryptocurrency addresses, cryptocurrency transactions;
   a client information database (404) communicatively coupled to the central approval server (401);
   transactions database (413) communicatively coupled to the central approval server (401);
   at least one client device (414, 415) provided with a registrant wallet (416, 417) comprising at least one unit of electronic money;
   wherein the at least one client device (414, 415) is configured to execute the method according to any one or more of the above causes.
7. A computer program comprising program code means for performing all the steps of the computer-implemented method according to any one or more of the above clauses, when said program is run on a computer or computational server.
8. A computer readable medium storing computer-executable instructions performing all the steps of the computer-implemented method according to any of one or more of the above clauses, when executed on a computer or computational server.
9. The method of any one or more of the above clauses, wherein the pair of approval public Key (405) and approval private key (406) can be changed manually or automatically in a regular period to avoid leakage of the approval public key and the approval private key to the public. After changing to a new pair of approval key, the old approval private key will be used for signing the transaction input (410), and the new approval private key will used for signing the whole transaction (i.e., all transaction's data) (412).
10. The methods of any one or more of the above clauses, wherein any currency addresses that are not generated through the submission of a valid credential to one of the central approval servers (401) are not valid, and are not able to receive any coins.
11. The method of any one or more of the above clauses, wherein the transaction network (202) can be modified to reject any transactions that do not the meet the central transaction criteria (501) or client transaction criteria (502) stored in one of the central approval servers (401).

The method of any one or more of the above clauses wherein any one or more of the following may be added:

the client transaction criteria (502) can be defined by a valid registered user to limit his/her own transactions;

the transaction criteria (501) can be defined by a central governing body (601) to stop suspicious transactions that is likely to be involved in illegal activities, such as money laundering;

individual transactions can be monitored with a defined rules to identify, record and report suspicious transactions that is likely to be involved in illegal activities, such as money laundering;

the legal identities of owners of individual currency addresses are stored in the client information database. For those transactions suspected of illegal activities, identities of their associated senders and receivers will be extracted from the client information database by tracing with the currency addresses of the senders and receivers. Subsequently, the suspicious activities and the associated client information will be reported to government agencies with respect to the regulations and laws in the associated countries;

The legal identities of owners for individual currency addresses are stored in the client information database. This fulfills the “know-your-customer” regulatory requirement. This allows the system to be used as a payment system for commercial activities;

The legal identities of owners for individual currency addresses are stored in the client information database. However, such information is not accessible to the public, in order to maintain the pseudonymous property of the cryptography-based electronic money (201) and its transaction network (202);

A user can change his/her credential (111) to stop coins being transferred out from a stolen main data file (e.g., wallet.dat file) of his/her currency wallet (301);

(i) legal identities of owners for individual currency addresses are stored in the client information database, (ii) any currency addresses that are not generated through the submission of a valid credential to one of the central approval servers (401) are not valid, and are not able to receive any coins (clause 18), and (iii) only valid registered users have a valid credential (112). When coins are stolen from someone, the theft(s) or the hacker(s) can be easily traced by retrieving legal identity(s) of the receiver(s) from the client information database according to the currency address(es) of the receiver(s). Therefore, the implementation of the above method(s) prevents a cryptocurrency from being stolen;

(ii) the amount of coins own by a valid registered user are completely and easily traceable and trackable by the central governing body (601) through analyzing the transaction records in the transactions database (413). Besides the capability of linking individual currency addresses to their owners, this unique property is contributed by recording unspent coins (if there is any) at the currency address from where the coins have just been sent/spent (322). This unique property allows applications of the system to financial and banking activities, particularly those requiring third-party auditing;

(iii) provide a practical solution for the issues related to cryptocurrency theft, KYC and AML, while maintaining user privacy; and/or

(iv) can be adopted or modified by the central banks or other financial institutions to issue their own digital currencies that are supported by a distributed ledger payment system, but also regulated by a central governing body.

Further, there is disclosed a method involving a system for creating a new cryptography-based electronic money or cryptocurrency with the traceable legal identities of senders and receivers in all money transaction. The method may be performed in a system comprising:
1. At least one server and at least one web-based registration interface, wherein the at least one server performs at least some, or all, of the following functions:
   Providing access to one or more potential or existing currency users;
   Providing an online interface for one or more potential currency users to register a user account with password protection, two factor authentication or multiple factor authentication;
      Requesting the submission of documents for proof of the legal identity of a registrant;
      Handling the verification of the legal identity of the registrant;
      Rejection of an account creation for registrants failing in legal identity verification;
      Creating of a personal/client account for individual successful registrants with successful verification of legal identity;
      Allowing a successful registrant to create a credential that comprises a label and a password;
      Allowing a successful registrant to change the credential and contact information;
      Encrypting the credential;
      Storing all the submitted information, particularly the legal identity and the encrypted credential, in a client information database;
      Sending the encrypted credential, which is newly generated or changed, to central approval servers;
      Mapping and storing multi-signature currency address(es), credential and legal identity of individual registrants.

One cryptography-based electronic money and its associated transaction network, wherein it performs at least some, or all of the following basic functions and unique functions:
1. Basic functions—common to those of all other cryptography-based electronic money
   Providing client wallet software to public;
   Connecting computers or servers through the client wallets;
   Using the connected computers or servers to form relay nodes of a transaction network;
   Generating a predefined amount of money units (coins) at a predefined speed;
   Protecting the ownerships of the coins by public/private-key cryptography;
   Recording the ownerships of the coins into a ledger of all transactions (e.g. blockchain) using the owners' currency addresses;
   Distributing the ledger of all transactions (e.g. blockchain) and its updates to people who are connected to the transaction network through the client wallet;
   Allowing a private key owner to send an amount of coins only without exceeding an amount of coins recorded at the corresponding currency address after reduction of the required transaction fee;
   Broadcasting all new transaction messages to all relay nodes in the transaction network;
   Verifying all new transaction messages at individual relay nodes;
   Recording the transaction information (including but not limited to sender currency address, receiver currency address, amount of coins being transacted, transaction fee, transaction time) into the ledger of all transactions (e.g., the blockchain);
2. Unique functions
   Restricting only valid registered users to generate one or more valid currency addresses to receive the coins by verifying the submitted credential with one of the central approval servers;
   Allowing only creation of multi-signature transactions in pay-to-script-hash format or any other compatible format;
   Allowing only creation of multi-signature transactions each requiring at least two private keys as signatures;
   Allowing only creation of multi-signature transactions in the presence of a valid credential;
   Restricting one of these private keys to be an approval private key from one of the central approval servers;
   Restricting the rest of the private keys to be client private keys, which are encrypted and stored in the client wallet(s);
   Sending all transaction requests from the client wallets to one of the central approval servers to obtain the approval private key for signing the transactions;
   Rejecting all transactions missing any one of the required private keys;
   Restricting transaction approval rules (including but not limited to requisition of a valid credential from the sender, requisition of one or more approval private keys from one of the central approval servers for signing transaction input and for signing whole transaction) for individual transactions by using a “pay-to-script-hash” script or any other compatible script that is built inside the source of the electronic money as the only script for transaction creation;

At least one computer or server for running client wallet software, wherein the at least one client wallet performs at least some, or all of the following basic functions and unique functions:
1. Basic functions—common to those of all other cryptography-based electronic money
   Serving as one of the relay nodes for relaying all transaction information in the transaction network;
   Serving as one of the relay nodes to verify and confirm all transactions that are broadcasted to the transaction network;
   Generating new coins through contributing to recording any new transaction information into the ledger of all transactions (e.g. the blockchain);
   Generating one or more pairs of cryptographic client public key and client private key for receiving and sending coins;
   Storing the client public-private key pairs of one or more currency addresses generated by the currency users;
   Serving as a client wallet for the currency users to receive and send coins;
2. Unique functions
   Serving as a client wallet to communicate between one of the central approval servers and registered currency users;
   Only generating currency addresses which are multi-signature addresses;
   Generating one or more multi-signature addresses from the client public key and the approval public key;
   Only storing one or more multi-signature addresses in the client wallet for sending and receiving coins;
   Sending one or more multi-signature addresses to the client information database for storage and mapping to legal identity of the owner of the address(es);
   Sending the generated valid multi-signature addresses to the central approval servers for storage;
   Submitting a credential of a valid registered user to one of the central approval servers for obtaining approval to generate one or more valid currency multi-signature addresses;
   Submitting a credential of a valid registered user to one of the central approval servers for obtaining approval to create one or more valid transactions to send coins to one or more currency addresses;
   Allowing only creation of transactions that use multi-signature addresses for both sending and receiving the coins;
   Recording unspent coins (if there is any) into the blockchain at the currency address from where the coins have just been sent;

At least one central approval server, wherein the at least one central approval server performs at least some, or all, of the following functions: the central server, in response to receiving a client request for permission for a transaction (311), is configured to examine the transaction for risk relating to anti-money laundering (AML) criteria, and at least one of: deny permission for the transaction; delay granting permission for the transaction for a period of time; and send an alert from the central server over a network to an electronic device associated with at least one of a governmental agency, a risk compliance officer, the client, and personnel associated with the system run by the central server.

The central approval server may, in some embodiments, be configured to take some or all of the following actions:
1. Retrieving new or updated credentials and their associated currency addresses from the client information database;
2. Storing and updating users' credentials and their associated currency addresses in the central approval database;
3. Generating, changing, encrypting and storing one or more pairs of approval public key and approval private key.
4. Communicating with the client wallet to generate one or more valid multi-signature currency addresses in the presence of a valid credential;
5. Providing approval public key to the currency wallet to create one or more multi-signature addresses,
6. Communicating with the client wallet to generate one or more valid transactions to send coins to one or more currency addresses in the presence of a valid credential;
7. Providing an approval private key, corresponding to the approval public key used in creation of the multi-signature address, to sign transaction input for one or more valid transactions.
8. Providing another approval private key, which can be the approval private key used in item 410 or the most recent approval private key, to sign the whole transaction for one or more valid transactions.
9. Storing all transaction information (including but not limited to transaction ID, sender currency address, receiver currency address, amount of coins being transacted, transaction fee, transaction time and IP addresses of sender and receiver's client wallets) in a transaction database.

Further, there is disclosed a method for personal/client identification and verification for transactions involving cryptography-based electronic money, the method comprising at least some, or all, of the steps of:
1. Verifying legal identity of a registrant;
2. creating a personal/client account, protected by at least two-factor authentication, for an individual successful registrant with successful verification of legal identity whereas the personal/client account facilitates mapping and storing individual registrants' legal identity and currency address(es) with the personal/client account;
3. receiving a credential, of an individual successful registrant, defining identity of the registrant, ownership of a currency address and sender identity of a transaction;
4. storing the registrant's legal identity and credential in one or more central approval servers;
5. providing a registrant wallet for sending and receiving at least one unit of electronic money;
6. recording ownership of at least one unit of electronic money into a ledger of all transactions (e.g. blockchain) using the registrant's currency address(es);
7. receiving and verifying a credential, which is submitted from a registrant wallet under a request for generation of a currency address, at a central approval server;
8. approving the creation of a multi-signature address as a valid currency address belonging to the registrant, by providing an approval public key from the central approval server to the registrant wallet;
9. generating a valid currency address for receiving at least one unit of electronic money by combing the registrant's public key and the central approval server's approval public key at the registrant wallet;
10. storing and mapping the registrant's legal identity, credential, one or more valid currency addresses in a client information database;
11. creating a transaction, in a “pay-to-script-hash” format or any other compatible format, each requiring at least two private keys as signatures at the registrant wallet;
12. restricting at least one of these private keys to be an approval private key from one of central approval servers;
13. restricting the rest of the private keys to be the registrants' private keys, which are stored in the client wallets;
14. restricting transaction approval rules (including but not limited to requisition of a valid credential from the sender, requisition of one or more approval private keys from one of the central approval servers for signing transaction input and for signing whole transaction) for individual transactions by using a “pay-to-script-hash” script or any other compatible script that is built inside the source of the electronic money as the only script for transaction creation;
15. receiving and verifying a credential, which is submitted from a registrant wallet under a request for creation of a transaction, at a central approval server;
16. verifying the transaction against one or more transaction criteria (including but not limited to those are predefined by the central governing body and/or the registrant) at the central approval server;
17. approving the execution of the transaction by signing the transaction with one or more private keys at the registrant wallet(s) and by signing the transaction with one or more the approval private keys at the central approval server;
18. recording the transaction message in the ledger of all transactions (e.g. blockchain);
19. storing the transaction information (including but not limited to transaction ID, sender and receiver's cryptocurrency addresses, amount of money transacted, time of transaction and IP addresses of sender and receiver's client wallets) in a transaction database;
20. broadcasting the signed transaction message to all relay nodes in a transaction network for confirmation;
21. tracing legal identities of the sender and receiver by mapping their currency addresses in the transaction database and the client information database when needed.

The systems and methods described herein may be modified by anyone or more of the following:

The systems and methods described herein may be modified to require two or more approval private keys from one or more independent central governing bodies for approving the transactions. Such modified electronic money and its associated payment network may have a higher degree of regulation and governance.

Alternatively, the systems and methods described herein may be modified to use single-signature addresses which are only signed by a single user or multi-signature addresses which are signed by two or more users for receiving and sending electronic money without requiring any approval private key from the central governing body for approving the transactions.

Another option instead of using multi-signature processes to obtain approval from a central server is to enforce some or all of the same functions of the central server(s) by placing any or all of such functions into a “smart contract,” i.e., a collection of computer instructions that require certain inputs or conditions to be met before allowing a transfer of CBEM. Thus, essentially equivalent computer code to that which would be carried out by the central server(s) is carried out by placing a central server function or functions at any point in between a transaction message and recordation of the transaction on the blockchain or distributed ledger. Smart contracts can be computer programs or apps that execute the terms of a contract. For example, a smart contract can include predetermined functions related to the execution, encryption, and enforcement of agreements between people or entities. A smart contract can be a settlement system for executing financial, or other, obligations upon the occurrence of the stated conditions. Such conditions can include the transfer of data, such as CBEM, verified documents, financial instruments, legal instruments, or other data.

The systems and methods described herein may be modified to use a single-signature addresses which are only signed by a central governing body or multi-signature addresses which are signed by two or more central governing bodies for receiving and sending electronic money without requiring any private key from a user for approving the transactions. However, users may have less protection on ownership of their electronic money. Validity of such modified electronic money and its associated payment network may depend on the trust and honesty of the central governing body(ies).

The systems and methods described above may have at least some or all of the following preferable features:

wherein transactions may be reversed by the system and/or user if a condition or specified conditions have not been met, e.g., by a certain time;

wherein there may be a hold time prior to recording a transaction on a ledger, such hold may be automatic, may be based on transaction size and/or other factors, and may increase with increasing transaction amount(s) and/or presence of other factors;

wherein the system may examine a potential transaction and/or an actual transaction e.g., during the hold time for AML and/or other financial compliance or risk;

wherein the system may identify and automatically hold, stop and/or reverse any transaction deemed suspicious in accordance with comparison to or based on one or more predefined criterion or criteria;

wherein such predefined criterion or criteria may include criteria concerning AML, KYC, CTF, BSA, FATF and/or any other government, intergovernmental, and/or entity suspicious financial transaction basis or bases;

wherein the above hold may be placed pending system notification from anyone or more of the following: the user, a third party such as a third-party delivery service, and/or other input;

wherein the hold on a transaction and/or reversal thereof may be based on a risk score (e.g., based on a compliance algorithm) received and/or determined by the system, which risk score meets or exceeds a predetermined threshold, and such risk score may be calculated based on a set of suspicious financial transaction rules which may include risks associated with one or more of the following: funds coming from and/or going to risky and/or illegal sources e.g., as determined by data from cross checking verified individual's identity stored in the system against one or more lists, e.g., of known and/or suspected terrorists, known and/or suspected money launderers, known and/or suspected financial criminals, cryptocurrency theft lists; cybercrime involvement lists; FATF blacklist and/or FATF risk criteria; no-fly list; transaction laundering indicators; and/or other compliance factors;

wherein the system may alone or in conjunction with other monitoring herein, check the user and/or recipient and/or information about the user and/or recipient against a list of IP addresses at the time of user registration in the system, any user update to the user's profile in the system such as an update to IP address, at the time of creation of a valid currency address, at the time of any proposed transaction or initiation of a transaction involving the user, and/or periodically;

wherein the system may freeze a user's account, e.g., such as a transaction recipient's account, based on any of the above compliance factors and/or other factors;

wherein the system may stop and/or reverse any transaction to a recipient and/or by a user from a country on a sanctions list and/or embargo list, e.g., based on location of an IP address and/or based on location of the user's or recipient's profile in the system;

wherein the system may, as part of any of the above and/or other financial crime detection steps, may also monitor users for suspicious activities, e.g., monitoring a user's web browsing history for suspicious web activity, e.g., visitation to known and/or suspected terrorists' websites;

wherein the system may, in addition to detection and/or monitoring for suspicious activities, issue alerts in response to detection of such suspicious activities, such alerts being displayed on a user interface such as a computer monitor, auditory alerts, and/or other alerts, preferably to personnel associated with the central server and/or system, and optionally to any user, preferably only an innocent (nonsuspicious) user or users, such as an innocent user involved in a purported transaction;

wherein the system may provide in lieu of the above alerts and/or in addition thereto, and/or for any potential transaction and/or potential recipient and/or other party to a potential transaction, a risk score of the type noted above;

wherein the system may use a wallet that communicates with the system via typical multi-signature channels for requesting a signature to a transaction and/or for responding to a request for a signature to a transaction for a user, which user may or may have signed the transaction;

wherein the system may receive a request for signature from a user, and may achieve the hold on a transaction by withholding signature until certain conditions are met, and/or may not sign a transaction in view of a threshold amount of risk and/or of a threshold type of risk of the transaction being part of a financial crime;

wherein the system may, for any of its actions herein, do so in response to a potential transaction such as a user signature on the transaction;

wherein the system may contain SAR, STR and/or related report compliance software, e.g., for creating SAR and/or STR and/or other required reporting triggered by system detection of a suspicious transaction and/or suspicious user; and

wherein the user may use an online and/or an offline wallet with the system.

Preferably, the pair of approval public key and approval private key can be changed manually or automatically in a regular period to avoid leakage of the approval public key and the approval private key to the public. After changing to a new pair of approval key, the old approval private key will be used for signing the transaction input, and the new approval private key will used for signing the whole transaction (i.e., all transaction's data).

Preferably, any currency addresses that are not generated through the submission of a valid credential to one of the central approval servers are not valid, and are not able to receive any coins.

Preferably, the transaction network can be modified to reject any transactions that do not the meet the central transaction criteria stored in one of the central approval servers.

Preferably, the client transaction criteria can be defined by a valid registered user to limit his/her own transactions.

Preferably, the transaction criteria can be defined by a central governing body to stop suspicious transactions that is likely to be involved in illegal activities, such as money laundering.

Preferably, individual transactions can be monitored with a defined rules to identify, record and report suspicious transactions that is likely to be involved in illegal activities, such as money laundering.

Preferably, legal identities of owners of individual currency addresses are stored in the client information database. For those transactions suspected of illegal activities, identities of their associated senders and receivers will be extracted from the client information database by tracing with the currency addresses of the senders and receivers. Subsequently, the suspicious activities and the associated client information will be reported to government agencies with respect to the regulations and laws in the associated countries.

Preferably, legal identities of owners for individual currency addresses are stored in the client information database. This fulfills the “know-your-customer” regulatory requirement. This allows the system to be used as a payment system for commercial activities.

Preferably, legal identities of owners for individual currency addresses are stored in the client information database. However, such information is not accessible to the public, in order to maintain the pseudonymous property of the cryptography-based electronic money and its transaction network.

Preferably, a user can change his/her credential to stop coins being transferred out from a stolen main data file (e.g., wallet.dat file) of his/her currency wallet. Preferably, (i) legal identities of owners for individual currency addresses are stored in the client information database, (ii) any currency addresses that are not generated through the submission of a valid credential to one of the central approval servers are not valid, and are not able to receive any coins, and only valid registered users have a valid credential. When coins are stolen from someone, the theft(s) or the hacker(s) can be easily traced by retrieving legal identity(s) of the receiver(s) from the client information database. Therefore, the implementation of the system prevents a cryptocurrency from being stolen.

Preferably, the amount of coins own by a valid registered user are completely and easily traceable and trackable by the central governing body through analyzing the transaction records in the transaction database. Besides the capability of linking individual currency addresses to their owners, this unique property is contributed by recording unspent coins (if there is any) at the currency address from where the coins have just been sent/spent. This unique property allows applications of our system to financial and banking activities, particularly those required third-party auditing.

Preferably, the systems provide a practical solution for the issues related to cryptocurrency theft, KYC and AML, while maintaining user privacy.

Preferably, the systems can be adopted or modified by the central banks or other financial institutions to issue their own digital currencies that are supported by a distributed ledger payment system, but also regulated by a central governing body.

### BRIEF DESCRIPTION OF THE DRAWINGS

These and other objects of the invention presented herein, are accomplished by providing a system and method for personal/client identification and verification. Further details and features of the present invention, its nature and various advantages will become more apparent from the following detailed description of the preferred embodiments shown in a drawing, in which:

FIG. 1 presents a registration and database system for capturing, verifying and storing legal identity of a new user for a cryptography-based electronic money;

FIG. 2 depicts a legal identity-linked credential authentication system for generation of a multi-signature currency address for receiving and sending a cryptography-based electronic money;

FIG. 3 shows a legal identity-linked credential authentication system and the two-party signature scheme for generation of a payment transaction of an amount of coins which are owned by a user and recorded at a multi-signature address;

FIG. 4 presents a diagram of a system according to the present invention;

FIG. 5 is an exemplary flow chart for a hold and/or reversal of a transaction based on risk factors;

FIG. 6 is a flow chart showing components of a risk assessment module; and

FIG. 7 is a system diagram of a variation of an embodiment or embodiments, wherein smart contract is used.

### NOTATION AND NOMENCLATURE

Some portions of the detailed description which follows are presented in terms of data processing procedures, steps or other symbolic representations of operations on data bits that can be performed on computer memory. Therefore, a computer executes such logical steps thus requiring physical manipulations of physical quantities.

Usually these quantities take the form of electrical or magnetic signals capable of being stored, transferred, combined, compared, and otherwise manipulated in a computer system. For reasons of common usage, these signals are referred to as bits, packets, messages, values, elements, symbols, characters, terms, numbers, or the like.

Additionally, all of these and similar terms are to be associated with the appropriate physical quantities and are merely convenient labels applied to these quantities. Terms such as “processing” or “creating” or “transferring” or “executing” or “determining” or “detecting” or “obtaining” or “selecting” or “calculating” or “generating” or the like, refer to the action and processes of a computer system that manipulates and transforms data represented as physical (electronic) quantities within the computer's registers and memories into other data similarly represented as physical quantities within the memories or registers or other such information storage.

A computer-readable (storage) medium, such as referred to herein, typically may be non-transitory and/or comprise a non-transitory device. In this context, a non-transitory storage medium may include a device that may be tangible, meaning that the device has a concrete physical form, although the device may change its physical state. Thus, for example, non-transitory refers to a device remaining tangible despite a change in state.

As utilized herein, the term “example” means serving as a non-limiting example, instance, or illustration. As utilized herein, the terms “for example” and “e.g.” introduce a list of one or more non-limiting examples, instances, or illustrations.

### DESCRIPTION OF EMBODIMENTS

The present invention relates to technical fields of cryptographic-based electronic money (CBEM), such as alternative cryptocurrency, and transaction systems. More specifically, the present invention relates to a method and system for creating of a new CBEM and its associated payment system that allows disclosure of the legal identities of senders and receivers in all money transactions, while maintaining the pseudonymous property of the CBEM.

The present invention allows inclusions of additional modules for monitoring all transactions and identifying those potentially related to illegal activities, and for including criteria, which are defined by a central governing body or CBEM users, to regulate or limit transactions.

As a result, the present invention provides a practical solution for the issues related to cryptocurrency theft, KYC and AML, while maintaining user privacy. Moreover, the present invention can be adopted or modified by the central banks or other financial institutions to issue their own digital currencies that are supported by a distributed ledger payment system, but also regulated by a central governing body.

To this end, the present invention involves an integration of three major processes, including (i) legal identity verification, (ii) credential authentication and (iii) a two-party signature scheme. Embodiments of the present invention may provide systems and methods for creation of a CBEM and its associated payment system that allows a central governing body to reveal legal identities of senders and receivers in any money transactions, while maintaining the pseudonymous property of the CBEM.

The credential authentication mechanism of the present invention allows a user to change the credential to stop coins being transferred out from a stolen wallet. Last and not least, as senders and receivers of all transactions can be revealed, the theft(s) or the hacker(s) who has stolen the coins can be easily traced by retrieving legal identity(s) of the receiver(s) from the client information database. As a result, the embodiments of the present invention can prevent CBEM coins from being stolen.

To be able to reveal legal identities of senders and receivers of all transactions of a CBEM, it requires the following two key elements:
1. legal identities of all receivers and senders of a CBEM;
2. prohibition of anonymous people to receive and send coins of a CBEM;

These two key elements can be obtained by allowing only registered users with a verified legal identity to receive and send a CBEM. For capturing and verification of legal identities, a web-based registration interface is created for individual registrants to submit information to provide and prove his/her legal identity, and only those people with a successfully verified legal identity are accepted as valid users. They can then receive and send the CBEM. However, the major difficulty is how to prohibit anonymous people to receive and send coins of a CBEM, particularly open-source CBEM.

Cryptographic-Based Electronic Money (CBEM) can be digital currency of any type that exhibits properties similar to physical currencies, but allows for instantaneous transactions, cryptographic security, and digital or virtual transfer-of-ownership. Examples of CBEM include virtual currencies, cryptocurrencies, cryptosecurities (e.g., any electronic/digital securities or tokens tied with securities), or even central bank issued “digital base money.” CBEM can also include all manner of electronic/digital tokens (e.g., representing a certificate or contract as a proof of ownership of a company share, proof of equity investment, proof of profit sharing right for a business, or proof of royalty sharing right for a patent, etc.), all manner of electronic/digital certificates for PoE (e.g., proof of entitlement), and any other suitable digital or virtual medium of exchange. Cryptography is commonly used in CBEM to authenticate devices and messages and to protect data from unauthorized observation or alteration. Examples of CBEM include Bitcoin, Ether, Ripple, Litecoin, Dash, or other suitable cryptocurrency.

CBEM transactions, regardless of type, can be stored in a distributed network, including distributed storage, a distributed ledger, blockchain, or other suitable distributed transaction mechanism. A distributed storage can include file or file segments stored on one or more networked nodes. The distributed storage is not limited to a specific format or protocol, but can include files of any type stored on any accessible network node, such as servers, desktops, mobile devices, removable storage, or other suitable device. In one embodiment, one file can be stored in its entirety on a single node and another file stored in another network node. Alternatively, a single file can be spilt into a plurality of segments and stored on one or more network nodes.

CBEMs, such as Bitcoin, are designed to be a decentralized payment system. Their computer programming codes are expected to be available for perusal by anyone at the open source online community. When a CBEM is open source, anyone can use the source code to create his/her currency address to receive and send the coins. Therefore, the KYC registration approach can only be applied to specific service providers, but not to all the coin users.

A distributed ledger can be a database or replicas of a database that are shared and synchronized across a distributed network or networks. The distributed ledger allows transactions to be publicly or privately viewable and replicated, making a cyberattack more difficult. The distributed ledger can also maintain consensus about the existence and status of shared facts in trustless environments (i.e. when the participants hosting the shared database are independent actors that don't trust each other). Consensus is not a unique feature of distributed ledger per se: other distributed databases also use consensus algorithms such as Paxos or Raft. Same for immutability: immutable databases exist outside DL (Google HDFS, Zebra, CouchDB, Datomic, etc.).

The distributed ledger can vary from a general distributed database as follows: (a) the control of the read/write access is truly decentralized and not logically centralized as for other distributed databases, and as a result; and (b) there is an ability to secure transactions in competing environments, without trusted third parties. Distributed ledgers structures can be linear, such as blockchain, or incorporate Directed Acyclic Graphs (DAG), such as Iota Tangle. Blockchain Iota Tangle, and Hedera hashgraph, are specific instances of a distributed ledger, having predefined formats and access protocols.

Blockchain is a distributed ledger that chronologically stores CBEM transactions. In a blockchain ledger, all CBEM transactions are periodically verified and stored in a “block” that is linked to the preceding block via a cryptographic hash. The blockchain ledger is publicly viewable, allowing the general public to view and keep track of CBEM transactions. Each network node can receive and maintain a copy of the blockchain.

In order to restrict the coin usage to only registered users, a new method has been developed to differentiate currency addresses generated by registered non-anonymous users (i.e., valid currency addresses) from those generated by non-registered anonymous users (i.e., invalid currency addresses), and another method has been developed to only allow those valid currency addresses to be used for receiving and sending coins.

The present invention provides a practical solution for these two tasks through an integration of three major processes, including (i) legal identity verification, (ii) credential authentication and (iii) a two-party signature scheme. Such integration requires technical changes in:
1. modifying Bitcoin's multi-signature transaction protocol;
2. linking it to a client information database;
3. making it as the compulsory transaction protocol, and
4. forcing one transaction signature to be a private key from one of the central approval servers.

The embodiments of the present invention may be achieved by the following key steps:

Step 1: Setting up a computer server and a web-based interface for capturing, verification and storage of legal identities of users and for creating user-specific credentials;
Step 2: Using the web-based interface to create credentials for regulating the process of currency address generation;
Step 3: Using a multi-signature approach for receiving and sending coins; and
Step 4: Enforcing pay-to-script-hash transactions regulated by specific rules.

The aforementioned steps will now be described in more details.

### Step 1: Setting Up a Computer Server and a Web-Based Interface for Capturing, Verification and Storage of Legal Identities of Users and for Creating User-Specific Credentials

The step of setting up a computer server and a web-based interface (e.g. BGCwallet.com) concerns users of a CBEM (e.g. Aten Coin). In the process of registration, a person should provide document/information about his/her legal identity (e.g. passport ID number and copy of identity page of his/her passport), and go through a process to verify his/her legal identity (e.g. identity verification service from MiiCard or IDchecker). A successful registration requires a successful verification of his/her legal identity. All the provided information will be stored in a client information database.

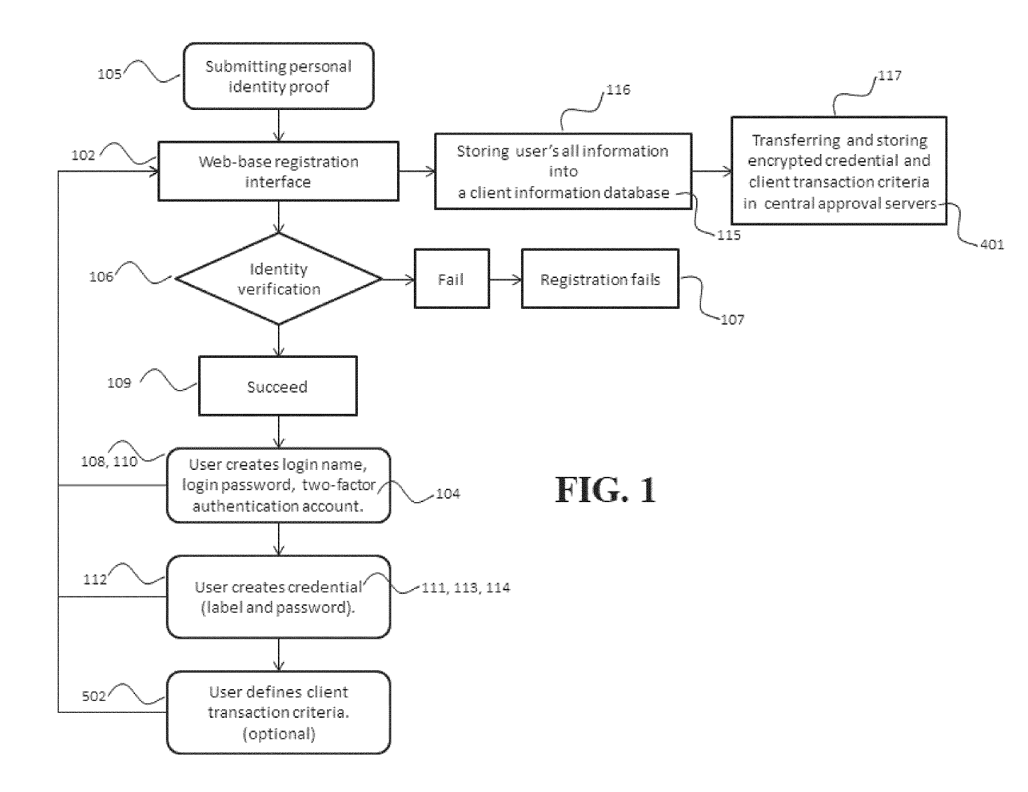

FIG. 1 presents a registration and database system for capturing, verifying and storing legal identity of a new user for a cryptography-based electronic money.

At least one server comprising at least one web-based registration interface (102), performs the following functions. First, at step (105) there is requested, via the web-based registration interface (102), a submission of documents for proof of the legal identity of a registrant. Next, at step (106) there is handled the verification of the legal identity of the registrant. An unsuccessful verification leads to a registration fail (107). Alternatively, a successful registrant (109) is allowed to create two factor authentication or multiple factor authentication (104) to prevent unauthorized access to his/her registered user account and malicious attack.

Two-factor authentication is a secure way to protect online user account (104). It works by requiring a user to identify oneself using two different things when he/she logs into his/her online account. The first authentication thing is a pair of login name and login password created by the user; the second authentication thing is a constantly changing token (e.g. a unique 7-digit code) which is tied to a physical device that is owned by the user, such as a cellphone or a personalized secure key generating device. Then, such online user account cannot be hacked without stealing the personal physical device. Multiple-factor authentication can also be possible by requiring a user to identify oneself using three or more different things when he/she logs into his/her online account (e.g. a pair of login name and login password, a cellphone and a smart identity card).

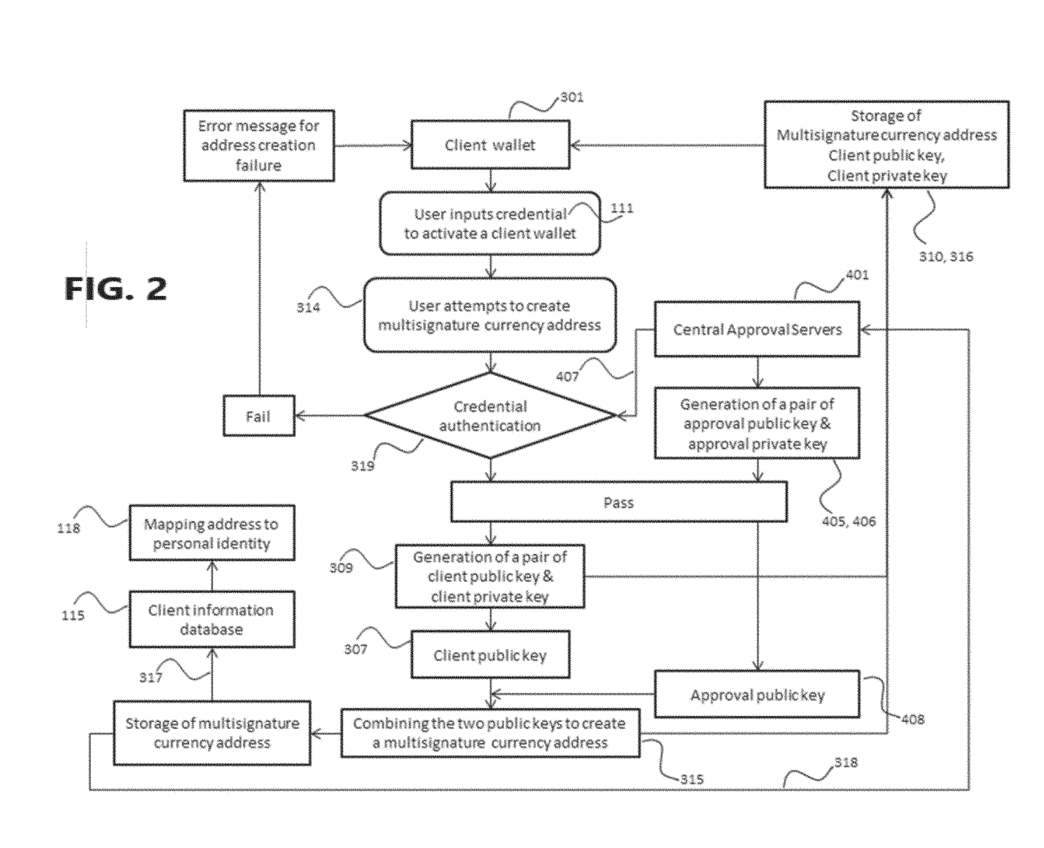

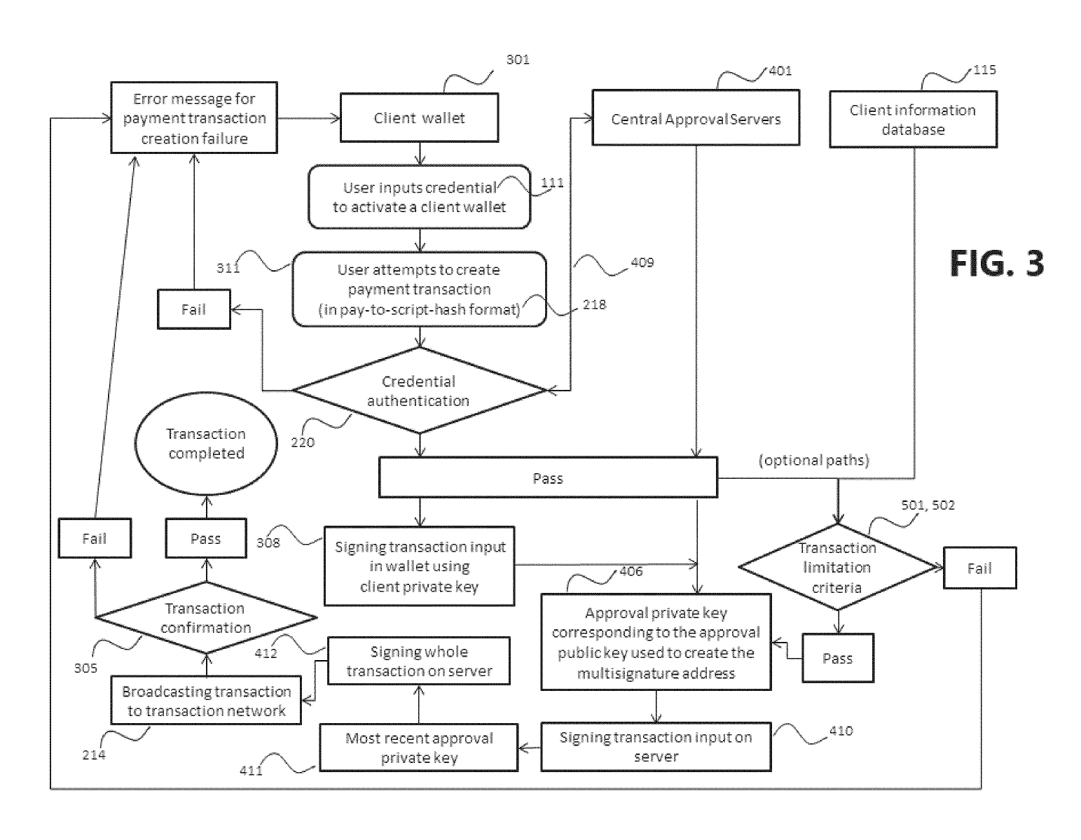

A successful registrant (109) is required to create a credential (111) that comprises a label and a password (112). Naturally a successful registrant (109) is allowed to change the credential and contact information (113), all of which are preferably encrypted at step (114). The credential is required for a user to generate his/her multi-signature wallet address(es) (FIG. 2) for receiving coins (e.g. atencoins), and for creating transactions (FIG. 3).

Optionally, at step 502, there may be defined, client transaction criteria, by a valid registered user to limit his/her own transactions. For example, a user can set a criterion that limits the maximum amount of coins being sent out from his/her currency address(es) within 24 hours. This can minimize the loss of his/her coins when his/her currency wallet is being stolen or hacked.

When the above are completed, at step (116) there is executed storing all the submitted information, particularly the legal identity and the encrypted credential, in the client information database (115).

Finally, at step 117 there is executed sending of the encrypted credential, which is newly generated or changed, to central approval servers (401). The central approval servers execute mapping and storing multi-signature currency address(es), credential and legal identity of individual registrants (118). For example, a multi-signature currency address is a unique string of 34 characters composed of numerical numbers, small and large alphabet letters (e.g. Aj8xFozUjo3GoNvi95kABpTjO2qQReZo5P); person identity is composed of (i) a full legal name printed on the user's national identity card or passport, (ii) national identity card/passport number and (iii) date of birth.

### Step 2: Using the Web-Based Interface to Create Credentials for Regulating the Process of Currency Address Generation

Using the web-based interface, only a valid registered user (106, 109) can generate a credential (111) (FIG. 1, 112), which is required for generating his/her multi-signature address(es) (as shown in FIG. 2) for receiving and sending coins (e.g. atencoins) (as shown in FIG. 3). The use of credentials prohibits non-registered, anonymous users to generate any valid multi-signature addresses to receive and send coins in the system. In other words, all valid currency addresses, for sending or receiving coins of a CBEM, are linked to real people with known, legal identities.

### Step 3: Using a Multi-Signature Approach for Receiving and Sending Coins

By design, one approval public key from one of the central approval servers and at least one client public key are required to generate valid multi-signature addresses for receiving and sending coins (FIG. 2). Before one can use the client wallet (301) to generate an address to receive coins, he/she must have input his/her credential (111) into the client wallet. In the process of address generation, the client wallet will first submit the credential to one of the central approval servers (401) through an electronic/digital data transmission network (e.g. the Internet) for validation (407).

After checking the credential is valid, i.e., successful matching to a valid and active credential in the database of the central approval servers (319, 401, 407), the central approval server will provide the approval public key (408) to the client wallet through the electronic/digital data transmission network. If the credential is found to be invalid or inactive, the central approval server will return a failure message to the client wallet. After receiving the approval public key, the client wallet will proceed to generate a multi-signature address (315).

After receiving the failure message, the client wallet will stop to the process of multi-signature address generation. In the presence of the approval public key, the client wallet generates (309) a pair of client public key (307) and private key (308) and stores (310) in the client wallet, and subsequently combines the approval public key (405) and the client public key (307) to create a multi-signature address (315), which hence is closely linked to the approval private key and the client private key. The multi-signature address is stored and displayed in the client wallet (316). The user can use the multi-signature address to receive coins of a CBEM (e.g. atencoins).

The presence of the approval public key in each multi-signature address dictates that all transactions have to obtain both the approval signature (i.e., the approval private key (406)) from one of the central approval servers and the client signature (i.e., the client private key (308)) for conferring validity.

Using this control system, only valid registered users can generate multi-signature addresses. These addresses can then be used to make transactions that need to be counter-signed by one of the central approval servers.

FIG. 2 depicts a legal identity-linked credential authentication system for generation of a multi-signature currency address for receiving and sending a cryptography-based electronic money.

The process starts from step (301) with providing client wallet, which is a network resource preferably accessible as a software. Next, the input user credentials, from step (111), are applied in order to activate a client's wallet. Subsequently, at step (314), a user attempts to create a currency address wherein the system only generates currency addresses which are multi-signature addresses.

Next, at step (319), there is executed submitting a credential, of valid registered users, to one of the central approval servers (401) for obtaining approval to generate one or more valid currency multi-signature addresses.

In case of a failure of approval, an appropriate error message may be generated. Otherwise, in case of approval, there is executed, at step (309), generating one or more pairs of cryptographic client public key (307) and client private key (308) for receiving and sending coins. These client public key and client private key are stored and associated with the client's wallet (310). In case of approval, there is also executed, at step 408, providing an approval public key (405), which is mathematically linked to an approval private key (406), from the central approval server to the client wallet.

Further, at step (315), there is executed generating one of more multi-signature addresses from the client public key(s) (307) and the approval public key(s) (405). The generated multi-signature currency address is stored and associated with the client's wallet (316).

Subsequently, at step (317), there is executed sending one of more multi-signature addresses to the client information database (115), for storage and mapping to legal identity of the owner of the address(es) (118).

### Step 4: Enforcing Pay-to-Script-Hash Transactions Regulated by Specific Rules

Bitcoin developers have currently created two different methods for creating and approving Bitcoin transactions using different scriptSig/scriptPubKey pairs. The two methods are pay-to-pubkey-hash and pay-to-script-hash.

The pay-to-pubkey-hash is the most commonly used method in daily Bitcoin transactions. In a pay-to-pubkey-hash transaction, a Bitcoin address is a 160-bit hash of the public portion of a public/private Elliptic Curve Digital Signature Algorithm (ECDSA) key pair, and a Bitcoin sender provides a Bitcoin address in scriptPubKey. In a pay-to-pubkey hash transaction, a sender transfers bitcoins directly to an owner of a public key.

In order to initiate a pay-to-pubkey hash transaction, the sender needs to provide a public key of which bitcoins are stored at the corresponding Bitcoin address and the corresponding signature (i.e., a paired private key), as well as a Bitcoin address for receiving the bitcoins. The receiving Bitcoin address is directly linked its corresponding pubic key and signature. When redeeming coins that have been sent to the Bitcoin address, the recipient provides both the signature and the public key. The script verifies that the provided public key does hash to the hash in scriptPubKey, and then it also checks the signature against the public key.

Addresses associated with pay-to-script transactions are hashes of scripts instead of a public key hash. To spend bitcoins through pay-to-script-hash, the process requires provision of a script matching the script hash and data which makes the script evaluate to true. In other words, one has to provide an input (i.e., an answer) to the script in question that the script accepts, and the transaction proceeds. If the input is invalid and the script will not be accepted, resulting in stoppage of the transaction.

Using pay-to-script-hash, one can send bitcoins to an address that is secured in various unusual ways without knowing anything about the details of how the security is set up. For example, the recipient might need the signatures of several people to receive bitcoins stored at a particular Bitcoin address, or a password might be required, or the requirements could be completely unique. For Bitcoin and all other current cryptocurrencies developed on the basis of the Bitcoin technology, pay-to-script-hash is not compulsory.

The pay-to-pubkey-hash is the standard method in Bitcoin transactions as well as in the transactions for all other current cryptocurrencies based on the Bitcoin technology. The pay-to-script-hash function is built into client wallet software of a cryptocurrency. A cryptocurrency owner can use the client wallet software to choose to use pay-to-pubkey-hash or pay-to-script-hash to create transactions.

According to the present invention, only pay-to-script-hash transactions are allowed in the CBEM transaction network. In contrast to Bitcoin and all other current cryptocurrencies based on the Bitcoin technology, this restriction is implemented inside the source codes of the CBEM, instead of only inside the source code of the client wallet software. In such way, a CBEM developer can enforce specific rules in all transactions, and this allows an implementation of a legal identity-linked credential authentication system to control all transactions. The legal identity-linked credential authentication system involves the use of user-specific credentials and multi-signature addresses for receiving and sending the CBEM.

In the legal identity-linked credential authentication system, only multi-signature addresses are used in the pay-to-script-hash transactions for receiving and sending the CBEM. Each client multi-signature address is linked to a script that includes a client pubic key (that is generated from the client wallet) (307) and an approval public key (that is generated from one of the central approval server) (405) for creating and signing transactions. Hence, every pay-to-script-hash transaction requires at least a client private key (308) and an approval private key (406) to make the transaction valid.

The script for pay-to-script-hash transactions is implemented inside the source codes of the CBEM, instead of only inside the client wallets. This allows the script to enforce the requirement of one or more approval private keys (406) from one or more central approval servers for initializing and signing all transactions. Because provision of the approval private keys can be regulated through the central approval servers, no one can create any pay-to-pubkey-hash or pay-to-script-hash transaction that can bypass the requirements, regulations and/or rules that are predefined at the central approval servers.

FIG. 3 shows a legal identity-linked credential authentication system and the two-party signature scheme for generation of a payment transaction of an amount of coins which are owned by a user and recorded at a multi-signature address.

To create a pay-to-script-hash transaction (218), a client's wallet (301) requires a signature (i.e., an approval private key) (406) from at least one of the central approval servers (401) to get permission. This request is sent with an API call to the central approval servers for authentication (220). In case of a failure of authentication, an appropriate error message may be generated.

If the credential submitted by the client wallet to the central approval servers (401) is valid (220, 409) and that requested transaction is not considered as suspicious according to predefined criteria (501, 502), it gets the signature from the client wallet (i.e., the client private key) (308) and the signatures (i.e., the approval private key(s)) (406, 411) from one of the central approval servers to approve the transaction (410, 412).

The script of a pay-to-script hash can be modified to require more than one client public key and/or approval private key, resulting in payment transactions requiring more than one signature from one or more clients (either senders or receivers) and/or from one or more approval agencies in order to proceed with a transaction. Furthermore, to increase the security, two different approval private keys can be used for signing transaction input (410) and for signing the whole transaction (412).

The present invention enforces all transactions requiring at least one approval private key from a central approval server as a signature in order to proceed with a transaction. Moreover, the provision of approval private keys requires a successful validation of a valid credential provided by the sender. Because all valid credentials are linked to individual client wallet addresses and owned by registered users, of whom legal identities have been verified and stored in the client information database (FIG. 2), only a registered user with his/her legal identity stored in the database can transfer any coins from his/her wallet addresses to other wallet addresses upon submission of a valid credential.

The credential provides a link for a central governing body owning the central approval servers and the client information database to uncover the legal identity of a CBEM sender or receiver when necessary. Because information of legal identity is not required in the whole process of a pay-to-script-hash transaction, the sender and receiver remain pseudonymous.

A central approval server may reject any transactions that do not the meet central transaction criteria (501) stored in at least one of the central approval servers (401). In particular, individual transactions can be monitored with predefined rules to identify, record and report suspicious transactions that is likely to be involved in illegal activities, such as money laundering. Any suspicious transactions and identities of the associated senders and receivers can be reported to the relevant government agencies for further action. The invention hence provides a practical solution for the current KYC/AML in compliance issues for Bitcoin and various alternative currencies.

Optionally, at step 502, there may be defined, client transaction criteria, by a valid registered user to limit his/her own transactions. For example, a user can set a criterion that limits the maximum amount of coins being sent out from his/her currency address(es) within 24 hours. This can minimize the loss of his/her coins when his/her currency wallet is being stolen or hacked.

The transaction is then broadcasted to the network of nodes (214) for confirmation (305). After a transaction is generated, it is sent to its transaction network for processing and has to be included in a block of the blockchain before becoming legitimate. Nodes accept the block only if all transactions in it are valid (i.e., properly signed) and the CBEM is not already spent. Nodes express their acceptance of the block by working on creating the next block in the chain, using the hash of the accepted block as the previous hash.

The process of implementing a transaction in a newly created block is called a transaction confirmation. Inclusion in one block is considered as one confirmation. When there are confirmations equal to or more than a predefined number (e.g. 6 in the case of Bitcoin, 10 in the case of Aten Coin), the transaction is considered confirmed. In the Bitcoin technology, this feature is introduced in order to protect the system form repeated spending of the same coins (i.e., double-spending).

The unique functions of the arrangement presented in FIG. 1-FIG. 3 are:
Allowing only creation of multi-signature addresses (313) as valid currency addresses; (314)
Allowing only creation of transactions that use multi-signature addresses (313) for both sending and receiving the coins; (321)
Allowing only creation of transactions in pay-to-script-hash format or any other compatible format (218); (311) Allowing only creation of transactions each requiring at least two private keys as signatures; (308, 406)
Restricting one of these private keys (308, 406) to be an approval private key (406) from one of the central approval servers (401);
Restricting the rest of the private keys (308, 406) to be client private keys (308), which are encrypted and stored in the client wallet(s) (301);
Restricting only valid registered users (109) to create valid credentials (111); (112)
Restricting only users who have a valid credential (111) to generate one or more valid multi-signature currency addresses (313) to receive the coins by verifying the submitted credential (111) through one of the central approval servers (401); (319, 407)
Restricting only users who have a valid credential (111), one or more valid multi-signature currency addresses (313) and the corresponding client private keys (308, 309) to create one or more valid transactions; (220, 320, 409)
Restricting only users who have a valid credential (111) to receive one or more approval private keys (406,411) from one of the central approval servers (401) for signing one or more transactions (410, 412) by verifying (220, 320, 409) the submitted credential (111) through one of the central approval servers (401);
Restricting only users who have received one or more approval private keys (406, 411) from one of the central approval servers (401) to create valid transactions by verifying (220, 320, 409) the submitted credential (111) through one of the central approval servers (401), and hence restricting only users who have a valid credential (111) to create valid transactions;
Linking individual credentials (111, 112, 113, 114) to users' legal identities (105); (FIG. 1)
Using individual credentials (FIG. 1, 111) to trace their owners' legal identities (105); (116)
Linking individual multi-signature addresses (313, 314) to users' credentials (111); (FIG. 2)
Using individual multi-signature addresses (313) to trace (118) credentials (111) of their owners (FIG. 2), and hence using the credentials (111) to trace (116) legal identities (105) of the owners (FIG. 1);
Using individual transactions to trace multi-signature addresses (313) of senders and receivers (FIG. 3), subsequently using the multi-signature addresses (313) to trace (118) credentials (111) of the senders and receivers (FIG. 2), and finally using the credentials (FIG. 1, 111) to trace (116) legal identities (105) of the senders and receivers;
   Allowing tracing and tracking (116) legal identities of senders (FIG. 1, 105) and receivers in all valid transactions (FIG. 3) because only users who have a valid credential (111) can create valid multi-signature addresses (FIG. 2) and create valid transactions (FIG. 3).

In some implementations, the methods described in connection with FIG. 1, FIG. 2, and/or FIG. 3 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method in response to instructions stored electronically on an electronic storage medium. The one or more processing devices may include one or more devices configured through hardware, firmware, and/or software to be specifically designed for execution of one or more of the operations of the method(s) illustrated in FIG. 1, FIG. 2, and/or FIG. 3.

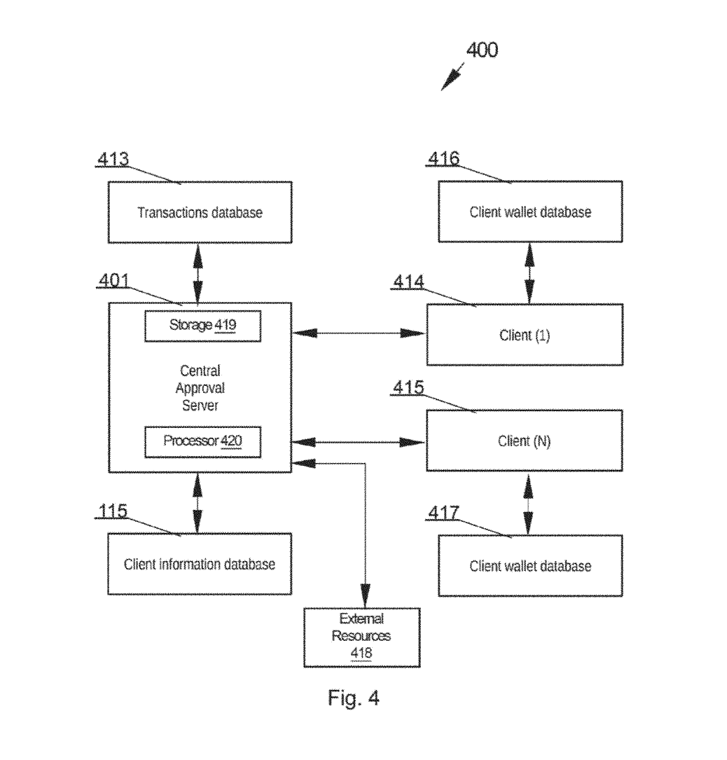

FIG. 4 presents a diagram of the system according to the present invention. The system is a client-server arrangement wherein the server is one or more central approval servers. The diagram illustrates an exemplary computer network (“system 400”) in which one or more implementations of the present invention may be realized. In some implementations, system 400 may include one or more servers 401. The server(s) 401 may be configured to communicate with one or more client computing platform(s) 414/415 according to a client/server architecture. The users may access system 400 via client computing platform(s) 414/415. The server(s) 401 and client computing platform(s) 414/415 may be configured to execute machine-readable instructions.

In some implementations, the server(s) 401, client computing platform(s) 414/415, and/or external resource(s) 418 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 401, client computing platform(s) 414/415, and/or external resource(s) 418 may be operatively linked via some other communication media.

A given client computing platform 414/415 may include one or more processors configured to execute machine-readable instructions. The machine-readable instructions may be configured to enable an expert or user associated with the given client computing platform 414/415 to interface with system 400 and/or external resource(s) 418, and/or provide other functionality attributed herein to client computing platform(s) 414/415. By way of non-limiting example, the given client computing platform 414/415 may include one or more of a desktop computer, a laptop computer, a handheld computer, a tablet computing platform, a NetBook, a Smartphone, a gaming console, and/or other computing platforms.

External resource(s) 418 may include sources of information, external entities participating with system 400, and/or other resource(s). In some implementations, some or all of the functionality attributed herein to external resource(s) 418 may be provided by resource(s) included in system 400.

Server(s) 401 and/or client computing platform(s) 414/415 may include electronic storage 419, one or more processors 420, and/or other components. Server(s) 401 may include communication lines, or ports to enable the exchange of information with a network and/or other computing platforms. Illustration of server(s) 401 in FIG. 1 is not intended to be limiting. Server(s) 401 may include a plurality of hardware, software, and/or firmware components operating together to provide the functionality attributed herein to server(s) 401. For example, server(s) 401 may be implemented by a cloud of computing platforms operating together as server(s) 401.

Electronic storage 419 may comprise non-transitory storage media that electronically stores information. The electronic storage media of electronic storage 419 may include one or both of system storage that is provided integrally (i.e., substantially non-removable) with server(s) 401 and/or removable storage that is removably connectable to server(s) 401 via, for example, a port (e.g., a USB port, a firewire port, etc.) or a drive (e.g., a disk drive, etc.). Electronic storage 419 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 419 may include one or more virtual storage resource(s) (e.g., cloud storage, a virtual private network, and/or other virtual storage resource(s)). Electronic storage 419 may store software algorithms, information determined by processor 420, information received from server(s) 401, information received from client computing platform(s) 414/415, and/or other information that enables server(s) 401 to function as described herein.

Processor 420 may be configured to provide information processing capabilities in server(s) 401. As such, processor 420 may include one or more of a digital processor, an analog processor, a digital circuit designed to process information, an analog circuit designed to process information, a state machine, and/or other mechanisms for electronically processing information. Although processor 420 is shown in FIG. 1 as a single entity, this is for illustrative purposes only. In some implementations, processor 420 may include a plurality of processing units. These processing units may be physically located within the same device, or processor 420 may represent processing functionality of a plurality of devices operating in coordination. Processor 420 may be configured to machine-readable instructions and/or components of machine-readable instructions by software; hardware; firmware; some combination of software, hardware, and/or firmware; and/or other mechanisms for configuring processing capabilities on processor 420. As used herein, the term “component” may refer to any component or set of components that perform the functionality attributed to the component. This may include one or more physical processors during execution of processor readable instructions, the processor readable instructions, circuitry, hardware, storage media, or any other components.

The client 414/415 and the server 401 may comprise data processing resources that may be realized using dedicated components or custom-made FPGA or ASIC circuits. These computing resources are suitable to store and execute software implementing steps of the method according to the present invention. The central approval server (401) processes client registration requests (FIG. 1), client cryptocurrency addresses (FIG. 2) client account update requests as well as cryptocurrency transactions (FIG. 3). The central approval server (401) thus cooperates with a client information database (404) (e.g. User X: legal name, date of birthday, home address, contact address, credential, cryptocurrency address, transaction criteria) as well as with a transactions database (413) (e.g. Transaction Y: transaction ID, sender and receiver's cryptocurrency addresses, amount of coins transacted, time of transaction and IP addresses of sender and receiver's client wallets).

Legal identities of owners for individual currency addresses are stored in the client information database (FIG. 1, 115). This fulfills the “know-your-customer” regulatory requirement and allows the system to be used as a payment system for commercial activities. However, such information is not accessible to the public, in order to maintain the pseudonymous property of the CBEM and its transaction network.

When coins are stolen from someone, the theft(s) or the hacker(s) can be easily traced by retrieving legal identity(s) of the receiver(s) from the client information database (115). Therefore, the implementation of the system prevents coins of the CBEM from being stolen.

Because of the pseudonymous or anonymous nature of Bitcoin and alternative cryptocurrencies based on the Bitcoin technology, a coin balance of individual coin owners is not traceable by only analyzing the public transaction records stored in the blockchain. Furthermore, by design, when one spends only part of the coins recorded at a specific currency address, the amount of unspent coins is recorded at a newly generated currency address. Through analysis of the blockchain, it is computation intensive for a third party to track where a received sum of coins has been finally transacted to and recorded at what addresses.

With the present invention, an amount of coins owned by a valid registered user is completely traceable and trackable by the central governing body through analyzing the transaction records in the transactions database (413). Besides the capability of linking individual currency addresses to their owners, this unique property of the present system is contributed by recording unspent coins (if there is any) at the currency address from where the coins have just been sent/spent. In other words, the amount of coins recorded at a currency address will become zero only after all of the coins, which were previously sent to that address, have been sent/spent (322). This unique property not only simplifies a third party process for tracing and tracking the ownership transfers of cryptocurrency coins through analyzing the transaction records in the blockchain, but also allows applications of the system to financial and banking activities, particularly those required third-party auditing.

The central approval server (401) communicates with one or more clients (414, 415) implementing client wallets (416, 417). A wallet can be operably connected to the central approval server (401) to send or receive data related to a transaction. The wallet can be implemented in software, hardware, online, or other suitable means. The wallet can store one specific cryptocurrency, or multiple cryptocurrency types.

A user of a wallet requests a transaction, which must be validated by one or more central approval servers (401). Therefore the clients are connected with the servers (401) via a suitable bidirectional communication link such as GSM, UMTS, DSL, Ethernet, etc.

The invention may include means to identify and stop any suspicious or unauthorized transactions automatically. Moreover, this invention prevents a CBEM from (i) being used for money laundering and (ii) being stolen. AML and KYC policies can be determined by a specific entity, or comport with established rules and regulations. The present invention hence allows the CBEM and its transaction network to comply with such AML and KYC policies and regulations. For example, GlobalVision Systems' PATRIOT OFFICER, an advanced rule-based intelligent BSA/AML/ATF system, can be applied to effectively automate the BSA/AML/ATF workflow by monitoring, screening, detecting, alerting, investigating and analyzing suspicious activities of all transactions.

In accordance with one variation of an embodiment or embodiments of the invention, a transaction may be delayed or held, and/or reversed, under certain conditions. Generally, a sender must sign a transaction at the time of making it. In one embodiment, a user cannot reverse a transaction. However, the company that controls the transaction network can effectively “reverse” a transaction (by holding the transaction until it expires) upon a user's request. In typical cryptocurrency, transactions cannot be reversed. However, in this variation of the invention, the system places a hold on a transaction for a period of time, e.g., a predetermined period of time and awaits the occurrence of a predetermined condition or conditions. For example, a user may create a transaction to send CBEM to a seller of goods or services. In response to a request from the user (buyer) to the system, e.g., the Central Server, the system will put a hold on completing the transaction until a predetermined period of time passes. If the seller delivers acceptable goods or services within the predetermined period of time, the buyer will not call back the transaction. If the seller does not deliver acceptable goods or services within the predetermined time, the buyer can void the transaction prior to the expiration of the predetermined time. This gives the seller incentive to perform.

A variation of this system could delay payment unless and until receiving a notification from a third party, e.g., a delivery service, such as Federal Express®, UPS® or DHL®, that goods have been shipped or have been delivered is received by the Central Server. Alternatively, the hold can also be based on transaction amount. For example, a user may wish to automatically set a transaction hold of one week or any period of time, for any transaction above a certain amount, or the system may only allow users to place a hold on transactions greater than a predetermined amount. The system may also have a maximum hold time. The maximum amount of time of the hold may be increased by a predetermined increment for another predetermined increment of increase of the transaction amount. The hold may also be implemented based on identification of: (1) a transaction originating from a risky source; (2) a party listed on a sanctions list; (3) a user's suspicious activity; (4) funds from a risky source; (5) funds from illegal sources; 6) exceeding a predetermined threshold for a number of detected suspicious activities; (7) other suitable determinations.

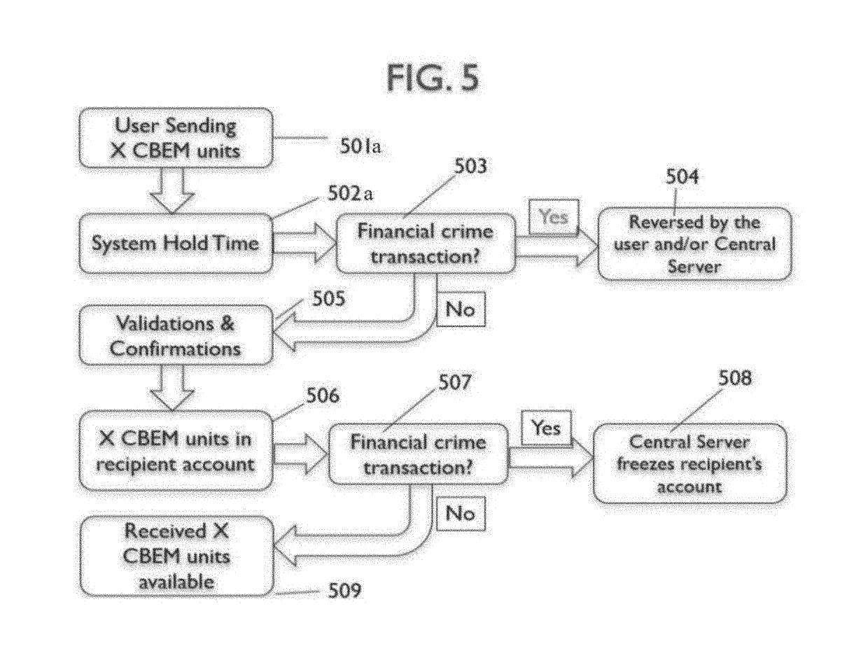

As shown in FIG. 5, an exemplary flow chart for a hold is shown. At step 511, a user creates a transaction to send X CBEM units to a recipient. At step 502a, the system (regulation utility, e.g., central server(s) and/or smart contract) places a hold time on the transaction in response to a user request and/or automatically, e.g., for unusually large transactions, and/or unusually repetitious transactions and/or other suspicious transactions as noted elsewhere herein and/or in accordance with government regulations. At step 503, the system may determine whether or not the specific transaction has sufficient likelihood of being a financial crime. If yes, at step 504 the system reverses the transaction (e.g., by canceling it or not approving it). In other versions, the user may cancel or otherwise reverse the transaction such as for reasons discussed above (goods or services not timely delivered) and/or due to financial crime detection. The transaction therefore would not become part of the ledger, e.g., it would not be published and recorded on the blockchain or ledger.

If a financial crime is not detected by the system at step 503, then the system enables normal publication, validation and confirmation as well as recording the transaction, at step 504. Thus, at step 505, the transaction is validated and confirmed. At step 506, the recipient has the CBEM units in his/her account. Nevertheless, in another optional variation, the system may detect and/or be advised of a financial crime transaction, and if so, at step 508 the system may freeze the recipient's account. If no financial crime at step 507, then at step 509 the recipient will have the X CBEM units available for use, e.g., sending to a third party.

Most preferably, a user signs a transaction in step 501a (sending X CBEM units), and so most preferably the user him or herself cannot reverse a transaction. Only the entity or party controlling the system (central server and/or smart contract) can reverse a transaction at step 504, with or without user approval. In another preferred version, the system can reverse the transaction where the user requests a hold on the transaction as mentioned above, and where a condition has (or conditions have) not been met (e.g., by the intended recipient) by a certain time. In this version, the system (central server and/or smart contract) acts like an automated escrow agent.

In some embodiments, a user may reverse a transaction, e.g., as follows: the smart contract may allow reversal for a limited time under some circumstances and/or in some central server embodiments, in creating a multi-signature client wallet, the central server creates a multi-signature address generated from three public keys. In some above embodiments, two key pairs (each pair having a public key and a private key), where one private key is with the client and one private key is with the central server, is used for ensuring that a client's proposed transaction obtains the central server's approval first, and may also be used for the central server to communicate with the client, e.g., via the client's wallet, when the client is initiating a transaction. To continue to use this type of process, yet give the client an ability to reverse a transaction, one way to do that is change from two key pairs to three key pairs (i.e., three private key and public key pairs). The first two key pairs may be the same as in the above embodiment. The client would also have an additional private key (and corresponding public key in this third key pair).

The central server may still have at one or more pairs of public key and private key, and the client now has two pairs of public keys and private keys. It should be noted that the multi-signature address may be generated from even more keys, such as four public keys.

The two private keys of a client can be stored in two separate .dat files in the same wallet. The first private key for initiating a transaction may be stored in a wallet.dat file as usual. The second private key for confirming a transaction may be stored in a confirm .dat file.

A client may use the first private key to initiate a transaction for sending a sum of CBEM. When it is time to confirm the payment and before a transaction expires, the client may press a confirmation button to use the client's second private key to sign the same transaction.

Alternatively, the client's wallet may be configured to use the client's second private key to automatically sign the transaction according to a computation instruction (e.g. automatically signing a transaction one week from the time of initiation). The client may stop or pause such automatic process by clicking a stop/pause button. Such a transaction expiry time may be a desired period of time by selecting a time at which the transaction becomes irreversible.

In monitoring, as noted elsewhere herein, transactions may be monitored against a defined set of rules (e.g., laws and/or regulations and/or by CBEM users to regulate or limit transactions) to identify, record and/or report (e.g., by a suspicious activity report (SAR) and/or a suspicious transaction report (STR)) suspicious transactions, e.g., transactions involved in illegal activities, such as money laundering. As noted in connection with FIG. 5, suspicious financial transactions may be held (step 502a) and/or reversed (step 504).

For example, the system may detect various forms of suspicious and/or improper activity in relation to CBEM transfers and CBEM wallets. One method of detection may involve determining a risk score based on:

1. Identifying when funds are coming from risky and/or illegal sources, such as by cross checking individuals' involved in any transactions, using their verified identities as determined herein, against a sanctions list or lists, such as a “no fly” list, a known terrorist list, a suspected terrorist lists, known money launderers' lists, sanctioned countries lists, e.g., by the US, United Nations and/or any other selected countries' lists, funds coming or going to any such suspicious person or entity, and/or any person and/or entity involved in criminal activity such as child pornography, theft of other cryptocurrencies, involvement in cybercrimes, etc.
2. Monitoring users for suspicious activities may further involve monitoring based on transaction size, e.g., a transaction value of at least a certain amount, e.g., $10,000 or above, and/or frequency of transactions, e.g., transactions totaling at least a certain amount between the same and/or to different currency addresses within a predetermined time, e.g., totaling at least $10,000 within one day, such as based on and mirroring the Bank Secrecy Act (BSA) and issuing a currency transaction report (CTR). Other examples of suspicious transactions may include where an account receives and/or transfers out an amount which is unusually large for the account, and/or if a person or entity has been detected for suspicious activity in the past.
3. An alert and/or score given that details the number of times a person has sent his or her other cryptocurrencies (not the CBEM of the subject application) outside of a wallet for the CBEM in accordance with the subject application.
4. Suspicious Activity detection can also include the use of Web browsers that can monitor suspicious activities by sending an alert pertaining to websites visited that are categorized as high risk or a threat by government agencies or associated parties.

In the subject invention, most preferably a wallet used in connection with the subject CBEM may also receive any cryptocurrency or at least multiple forms of cryptocurrency, such as the original bitcoin, Ether and/or Dash cryptocurrency.

By way of example, if a user has a wallet in a most preferred embodiment, and uses such wallet for all digital Currency transactions, such wallet will be in communication with the central server (and/or the smart contract code) so the system can monitor and detect for suspicious activities outside of the use of just a CBEM in accordance with embodiments of the invention. By way of further example, a bank and/or other financial institution may require its customers to use wallets in accordance with the most preferred embodiment, which can detect and send alerts to a bank and/or other financial institution when the system detects transactions with non-system wallets and/or non-system cryptocurrency.

Transaction risk assessment, be it AML and counter-terroriser finance act (CTP)) risk assessment and/or other financial transaction risk assessment mentioned herein or otherwise, is typically done through determining risk scores based on third party sources based on factors discussed herein and other factors. The Financial Action Task Force on money laundering a FATF) is an intergovernmental organization that provides recommendations and guidelines for AML and anti-terrorism measures. It also issues a list of Non-Cooperative Countries or Territories, more commonly called the FAIT Blacklist. Anti-financing of terrorist activities can also be achieved by monitoring IP addresses (1) at the time of user registration; (2) at time of creation of transaction address; and (3) at the time of initiation of a transaction, and through monitoring coin usage patterns.

A specific form of money laundering that is preferably included in monitoring and issuing alerts and reporting is transaction laundering. Transaction laundering is a type of money laundering where a merchant is set up to receive payments (e.g., from purported customers). There may be no actual sale of goods or services. Alternatively, a business may be set up that sells illegal items (stolen or counterfeit goods, weapons and/or drugs) and process payments received by routing such payments to legitimate online stores that are set up to appear to sell innocent-looking goods. Transaction laundering is much easier in these days of internet businesses, which often do not need to meet strict KYC requirements to set up. The purported innocent businesses may be run from anywhere in the world via the internet. For these reasons and others, transaction laundering is especially difficult to stop. However, at least with the CBEM of embodiments of the subject invention, the user must have a verified identity.

Alerts or scores given from data generated from third party sources may be used and/or use of one or more software solutions. Existing software solutions for financial transaction compliance may preferably include the below:
AML360, by AML360, in Sydney, Australia, www.AML360software.com;
SafeWatch Profiling, by EastNets®, in New York, N.Y., www.EastNets.com;
AML Manager, by Fiserv., in Brookfield, Wis., www.fiserv.com; and

Software addressing AML business requirements may include the following as well as other monitoring:

Transaction monitoring systems to identify suspicious patterns of transactions which may result in the filing of Suspicious Activity Reports (SARs) or Suspicious Transaction Reports (STRs).

Currency Transaction Reporting (CTR) systems to monitor large cash transaction reporting requirements ($10,000 and over in the U.S.)

Customer identity management systems to check and monitor various negative lists (such as OFAC) and represent an initial and ongoing part of KYC requirements. Electronic verification can also check against other databases to provide positive confirmation of ID such as (in the UK: electoral roll; the “share” database used by banks and credit agencies; telephone lists; electricity supplier lists; post office delivery databases.

Compliance software.

Additional monitoring may include checking the IP address or addresses associated with a registered user against one or more databases of IP addresses associated with terrorist financing activity, money laundering, financial money laundering and other illicit activity at any one or more, preferably all, of the following times: at the time of user registration in the system and/or any user update that results in a change to the associated IP address or addresses, periodically at predetermined time intervals, at a time of creation of a transaction address, at a time of any proposed transaction or initiation of a transaction, and/or at a time of any transaction pattern meeting a predetermined criterion or predetermined criteria for suspicious activity, and/or at any time of reaching a threshold risk score in any respect (amount of transaction, transaction to a suspicious person or entity, etc.).

Moreover, by way of further example, the user's IP address or addresses may be checked, at the same times as above, to see if the address or addresses are located within any country under embargo and/or sanction as a basis to stop and/or reverse a transaction at the time of the transaction.

The monitoring software may include rules from and/or rules related to:
FinCEN—Financial Crimes Enforcement Network
BSA—Bank Secrecy Act
AML—Anti-Money Laundering
SAR—Suspicious Activity Report
RMLO—Residential Mortgage Loan Originator
HIFCA—High Intensity Financial Crime Area
HIDTA—High Intensity Drug Trafficking Areas
OFAC—Office of Foreign Assets Control
Department of the Treasury
   Financial Crimes Enforcement Network (FinCEN)
   Internal Revenue Service (IRS)
   Consumer Finance Protection Bureau (CFPPB)
   State Regulators

Some or all regulation compliance checking and/or other functions of the central server may be controlled by the source code inside a smart contract.

1) A permissioned transaction address is still needed, but in this configuration it can be a single-signature or a multi-signature currency address.
2) The permission currency address, which can be linked to client's identity, is created as previously described herein.
3) A permissioned transaction network is still needed, but in this configuration the permission control is achieved by using a smart contract for enforcing some or all of the same functions of the central server(s) that requires certain inputs or conditions to be met before allowing a transfer of CBEM.
4) Some or all control/approval processes by clients/users and/or by the governing body will be integrated into the smart contract.

The software that runs the distributed ledger would be programmed to receive the signed transaction and hold it, e.g., until various conditions are met, and then record it. The hold could be before or after publication and validation. One condition would be to get the central server's approval.

Optionally, the smart contract could initiate its own or the central server's check of the risk score and if the risk score meets or exceeds a threshold, the smart contract could deny the transaction. The smart contract would be in essence an arm of the central server, as it would just move some of the control already belonging to the central server to the software running the distributed ledger.

The following exemplary workflow may be used.

A client initiates sending of CBEM by initiating a smart contract, according to which a sending of CBEM will go through a number of steps preset in the smart contract and a valid sending of CBEM requires the fulfillment of criteria preset inside the smart contract.

The steps and criteria, which are preset inside the smart contract, may include the following chronological events, e.g., as outlined in FIG. 5. Another example would be holding a transaction; checking for fulfillment of various conditions; success or failure in completion of the smart contract (e.g. central server's check of the risk score, approval by the central server); success; and publication to the network and verification, and recordation.

For checking fulfillment of various condition, the smart contract can either complete all required work by itself, or interact with the central server for completion of all required work. In the latter case, the smart contract serves as an interface to submit requests to and collect answers from the central server(s). The smart contract will then use the central server(s)′ answers to check if all required conditions are satisfied or not. The smart contract may also check any other sources for fulfillment, such as third party sources.

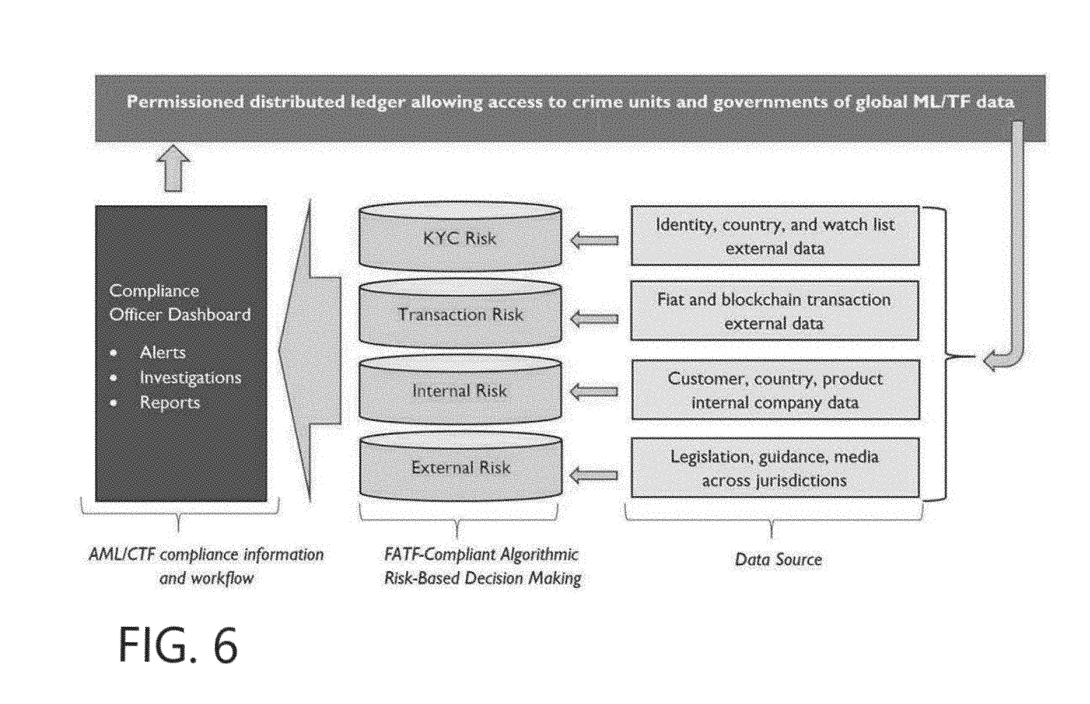

FIG. 6 is a flow chart showing components of an AML and risk assessment module, which includes connecting to various databases with relevant data, analyzing transactions and proposed transactions using the data from such databases along with data from the identity database of the present system, data from the transactions database of the present system, and data from the proposed transaction (and/or transaction being reviewed) and using compliance algorithms, e.g., from FATF requirements, determining risk, and then reporting such risk as needed/required, as well as taking action(s) of FIG. 5 above to hold or reverse transactions, and/or freeze accounts. For example, when the user proposes a transaction via the system (step 501a of FIG. 5), the user's wallet requests approval of the transaction from the central server. There may be a hold (step 502a) while the system runs the monitoring (step 503) in accordance with FIG. 6, and as explained herein. Similarly, when the system monitors as in step 507, the process depicted in FIG. 6 and explained herein may be followed. The compliance algorithm, e.g., an FATF compliant algorithm, may determine:
KYC risk from client identity, recipient identity, location (country) the client and recipient, watch list data and other external data;
Transaction risk from fiat and blockchain transaction data and external data;
Internal risk from customer identity, country of customer, product data, and internal company data; and
   External risk from legislation, guidelines, media information, and cross jurisdictional information.

The algorithm processes the input data and determines a risk level or score concerning the various risk types, and may transmit a signal such as an alert, to an electronic device (e.g., a company compliance officer's computer), e.g., by transmitting and displaying on the device, e.g., a display on its monitor and/or an audible alert and/or a visual alert such as a blinking light, in the event of a risk score above a predetermined threshold. There may be thresholds for various types of risks monitored, e.g., AML, KYC, CTF, BSA, and/or FATF etc. The compliance officer's device and/or the system may automatically generate a SAR, STR and/or other report and may automatically transmit it to the appropriate authority(ies). The transaction, in the event of sufficient risk (meeting a predetermined threshold) may be stopped, delayed, and/or reversed, prior to the central server granting permission, after permission is granted by the central server and before publication to the network, after publication and/or after validation (although once validated by the network, it is preferred not to reverse the transaction). The recipient's CBEM account may be frozen, as well as the sender's account, if warranted, at any one of these times, and particularly for transactions that are already validated.

In other embodiments, use of a multi-signature wallet address whether the wallet is stored online or offline is desirable. Multi-signature enables the central system to be one of the M of N (e.g., two out of three) signatures required for signing a transaction. Therefore, the system can, as noted elsewhere herein, receive the proposed transaction from a user via the multi-signature wallet, perform financial transaction monitoring as noted herein, and sign or hold off on signing the transaction unless and until there is no significant suspicious activity or other financial risk associated with the transaction.

The system may, e.g., be the same as or similar to that shown in FIG. 4. Storage 419 may, contain the system instructions, e.g., in non-volatile memory. The central approval server 401 may have one or more monitors (graphical user interfaces) associated with it for any display herein, as well as any alarms and/or other alert mechanisms referred to herein. Storage 419 may, also include software referred to herein for monitoring, detecting and/or alerting in response to financial risks and/or risk score determinations mentioned herein. The external resources 418 may include the various databases needed to obtain data for use in calculating risk and/or external software used in calculating risk referred to herein.

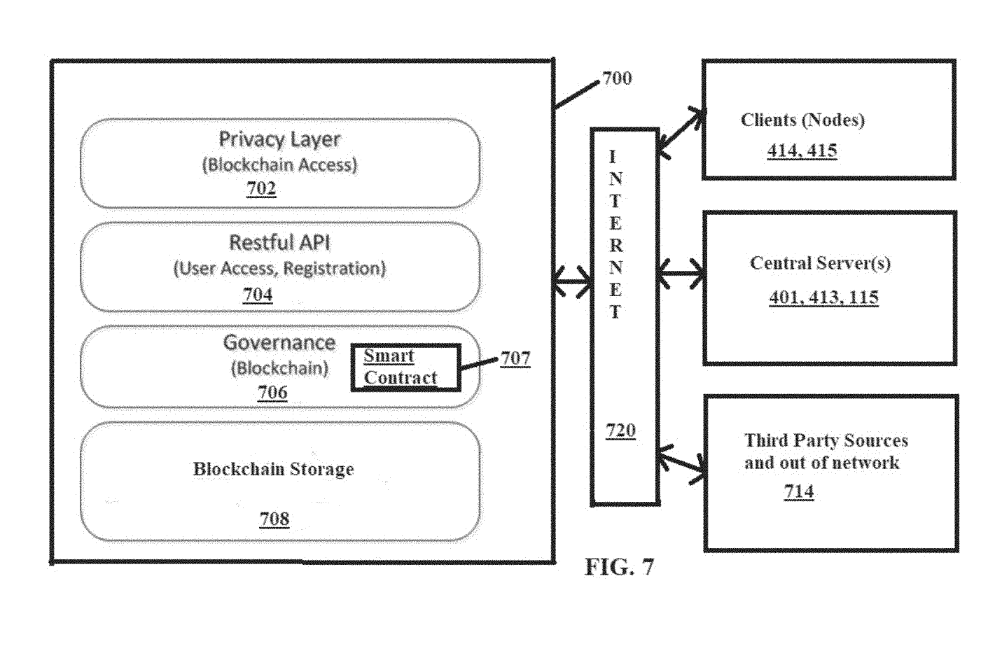

FIG. 7 shows an exemplary modified system overview in accordance with one or more implementations or variations of FIG. 4, where an applied blockchain (or distributed ledger) 700 and a smart contract are used. As shown, there is the applied blockchain or distributed ledger having a privacy layer 702 which may function as a permissioning administration layer for blockchain access. It may be built on, for example, an Ethereum blockchain, e.g., blockchain 706 for governance. As shown, there may be a mechanism for the storage of files (e.g., biometric data and other files). These items may be coupled with an application programming interface (API) 704 such as a restful API, and e.g., a blockchain database 708 to provide and/or enhance storage, such as BigChainDB. This may be coupled with, for example, a biometric app and a website, among other things. Other configurations may be used. In this embodiment, governance of the blockchain may include smart contract 707. In fact, the blockchain 706 may be replaced with a distributed ledger in this embodiment, and in some or all embodiments herein. Further, in some or all embodiments, other forms of distributed storage may be used.

As in FIG. 4, there are client nodes 414, 415 and there may be a central server or servers 401 which may include transactions database 413 and a client information database 115. Third party sources and out of network parties 714 may include the external resources of FIG. 4 and may include out of network nodes. All of the system components may communicate via internet 720. In some or all of the above embodiments, the central server functions may be split up among more than one central server. In some or all of the above embodiments, a central server or servers may give permission to a client when the central server or servers has given the client information (such as information about the suspiciousness of the transaction/likelihood of money laundering) about the transaction (permissioned transaction) which the client wants to enter into. In other embodiments, the central server or servers may deny the transaction. As explained elsewhere herein, this is done by requiring an automated approval in the presence of a condition or conditions, which may be determined by the central server or servers. One specific way this is done is by use of a multi-signature wallet where the central server must sign off on a transaction that the client creates before the transaction is allowed to proceed. Another way this approval for a transaction may be achieved is by a process known as “smart contract.” In a smart contract, computer instructions determine whether a required condition or conditions are present for the transaction to proceed. In effect, some or all of the central server's or servers' functions are simply performed by computer instructions added to the source code of the software running on a peer-to-peer network that controls the blockchain. Smart contracts are formed, e.g., on a server or as a decentralized app (also known as a DApp). A DApp has a front end (in HTML) and a back end (essentially a database for the front end).

In some implementations, at least one dedicated node performs the signing of the verification of the personal identity of the first individual or user. A given dedicated node may include one or more server(s). The given dedicated node may be a public node or a private node configured for creating new blocks and/or for signing verification.

In some implementations, the system may be run by a System Regulation Utility (SRU) or system processor. The system processor may include one or more servers and/or a smart contract. The system processor or server(s) may be configured to communicate with one or more computing platforms according to a client/server architecture, a peer-to-peer architecture, and/or other architectures. The users may access system via computing platform(s). The server(s) and/or smart contract may be configured to execute machine-readable instructions. The machine-readable instructions may include one or more of System Regulation Utility (SRU) and/or other machine-readable instruction components. The SRU can receive CBEM transactions and can be operatively coupled to the distributed storage, distributed ledger, blockchain, or other suitable distributed transaction mechanism. The SRU may be implemented as a smart contract and/or as computer instructions on the server or servers, and may be considered to be run by a system processor. The system processor may be formed by the smart contract acting together with a central server, or just a central server or just a smart contract.

Two examples of how alerts and/or reporting of suspicious activities may occur are as follows: Example A: A sum of CBEM is sent from a currency address outside of our compliant network to a currency address in our compliant network. Example B: A sum of CBEM is sent from our compliant network to a currency address outside of our compliant network.

In Example A, the central server may take any or all of the following actions in response to detection:
1. Conduct a compulsory AML check (retrospective transaction analysis);
2. Alert the user (client) that the system detected receipt of a sum of CBEM from outside of the compliant network;
3. The user or client can choose to obtain (e.g., purchase) an analysis report of the AML risk associated with the transaction; and/or
4. The system provides an appropriate flag or label associated with that particular sum of CBEM and also links to the system's analysis result of (i) the origin of the sum of CBEM and (ii) previous transactions associated with the sender's currency address.

In Example B, the system may, at the time of the user or client making a transaction (sending) request, a warning message will be given to such user informing the user that he is sending a sum to a currency address which is outside of the complaint network. There may also be an option for the user to use the system's AML check (a retrospective transaction analysis) to evaluate the AML risk of the intended recipient currency address at least in part based on that recipient currency address's previously associated transactions.

The system, optionally, may also provide the user with an opportunity to provide an additional confirmation before the user can send the sum of CBEM. Such additional confirmation request may contain an alert message about the risk associated with such CBEM sending action, e.g.:

(i) the sender should be responsible for the consequences of engaging in such a transaction with its attendant AML risk; and/or
(ii) an assessment of the AML risk associated with the intended recipient's address such as low, medium or high, which assessment may, e.g., only be provided when the user elects to purchase the system's AML check.

Preferably, in both Examples A and B, the AML check is compulsory, but the user can choose to pay to obtain the AML risk analysis report, and/or the central server may automatically prepare a SAR or STR, or other report to the relevant governmental regulatory department if it is found that that the sender (Example A: report e.g., may contain sender currency address, its previous transactions and origin of the CBEM sum) or recipient (Example B: report, e.g. may contain recipient currency address and its previous transactions) is associated with illicit transaction activities.

It can be easily recognized, by one skilled in the art, that the aforementioned method for personal/client identification and verification may be performed and/or controlled by one or more computer programs. Such computer programs are typically executed by utilizing the computing resources in a computing device. Applications are stored on a non-transitory medium. An example of a non-transitory medium is a non-volatile memory, for example a flash memory while an example of a volatile memory is RAM. The computer instructions are executed by a processor. These memories are exemplary recording media for storing computer programs comprising computer-executable instructions performing all the steps of the computer-implemented method according the technical concept presented herein.

The invention provides a useful outcome, which is improved security and traceability of transactions. This result is also concrete and tangible since statistical measurements show improved security and fewer attempts of CBEM stealing. Therefore, the invention provides a useful, concrete and tangible result. The machine or transformation test is fulfilled by the fact that the improved security achieved by means of the present invention requires requiring generations of multi-signature addresses and pay-to-script-hash transactions and their specific modifications, implementations and applications thereby transforming data associated with cryptocurrencies. Due to a specific implementation scheme the idea is not abstract.

While the invention presented herein has been depicted, described, and has been defined with reference to particular preferred embodiments, such references and examples of implementation in the foregoing specification do not imply any limitation on the invention. It will, however, be evident that various modifications and changes may be made thereto without departing from the broader scope of the technical concept. The presented preferred embodiments are exemplary only, and are not exhaustive of the scope of the technical concept presented herein.

Accordingly, the scope of protection is not limited to the preferred embodiments described in the specification but is only limited by the claims that follow.

What is claimed is:

1. A system for monitoring and restricting transactions involving cryptography-based electronic money (CBEM), the system comprising:
a system processor running a system regulation utility configured to, in order to process client identity registrations, client currency addresses, CBEM transactions:
communicate with a client wallet to generate one or more client's permissioned currency addresses;
approve a request for generation of one or more client's permissioned currency addresses;
communicate with the client wallet to create one or more permissioned transactions;
approve one or more transactions to send a unit of CBEM to a currency address;
examine a transaction using transaction criteria defined by a central governing body or client; and
store transaction information in a transactions database;
wherein the system further comprises:
one or more permissioned currency addresses;
a permissioned transaction network;
a client information database communicatively coupled to the system processor;
a transactions database communicatively coupled to the system processor; and
at least one client device provided with a client wallet;
wherein the at least one client device is configured to:
obtain permission from the system processor to generate one or more permissioned currency addresses;
obtain permission from the system processor to create one or more permissioned transactions to send a unit of CBEM to a receiver's currency address;
create one or more permissioned transaction to send a unit of CBEM to a receiver's currency address by signing the transaction; and
wherein the central server, in response to receiving the permissioned transaction, is configured to delay the permissioned transaction for a period of time before providing its permission for the transaction, where permission is contingent upon a determination that a condition or conditions are met or are not met.

2. The system of claim 1, wherein the system processor is further configured to:
create a personal account for a client;
verify and record real, personal identity information submitted by a client;
record an identity verification credential submitted by a client;
record a permissioned currency address generated by a client;
map and store a permissioned currency address, personal identity information and an identity verification credential of a client in the client information database; and
record ownership of the at least one unit of CBEM into a transactions database using a client's currency address.

3. The system of claim 1, wherein the system processor comprises a central server.

4. The system of claim 1, wherein the system processor comprises a processor controlled using a smart contract.

5. The system of claim 1, wherein the system processor comprises a central server and a processor controlled by a smart contract.

6. The system of claim 2, wherein the condition or conditions relate to a level of suspicion with respect to the transaction's compliance with transaction criteria concerning at least one of AML, KYC, CTF, BSA and FATF, and wherein when the central server determines that there is a requisite level of suspicion, the system processor stops the transaction.

7. The system of claim 1, wherein the system processor, in response to passage of the predetermined period of time without receiving an indication that the at least one condition or conditions has been met, stops the transaction.

8. The system of claim 1, wherein the system processor, in response to passage of the predetermined period of time without receiving an indication from the client to cancel the transaction, allows the transaction.

9. The system of claim 1, wherein if the system processor does not receive an indication that the at least one condition or conditions has been met within the period of time, the system processor stops the transaction.

10. The system of claim 1, wherein the indication of the condition or conditions is received by the system processor from a third party electronic device.

11. A system for monitoring and restricting transactions involving cryptography-based electronic money (CBEM), the system comprising:
a system processor configured to, in order to process client identity registrations, client currency addresses, CBEM transactions:
communicate with a client wallet to generate one or more client's permissioned currency addresses;
approve a request for generation of one or more client's permissioned currency addresses;
communicate with the client wallet to create one or more permissioned transactions;
approve one or more transactions to send a unit of CBEM to a currency address;
examine a transaction using transaction criteria defined by a central governing body or client; and
store transaction information in a transactions database;
wherein the system further comprises:
one or more permissioned currency addresses;
a permissioned transaction network;
a client information database communicatively coupled to the system processor;
a transactions database communicatively coupled to the system processor; and
at least one client device provided with a client wallet;
wherein the at least one client device is configured to:
obtain permission from the system processor to generate one or more permissioned currency addresses;
obtain permission from the system processor to create one or more permissioned transactions to send a unit of CBEM to a receiver's currency address;
create one or more permissioned transaction to send a unit of CBEM to a receiver's currency address by signing the transaction; and
wherein the system processor, following receiving the permissioned transaction and validation and confirmation of the permissioned transaction by the transaction network and in response to a receipt of the CBEM in the recipient's account, is configured to freeze the recipient's account from transferring CBEM in response to detection of a level of suspicion with respect to the transaction's compliance with transaction criteria defined by a central governing body or client.

12. The system of claim 11, wherein the system processor is further configured to:
create a personal account for a client;
verify and record real, personal identity information submitted by a client;
record an identity verification credential submitted by a client;
record a permissioned currency address generated by a client;
map and store a permissioned currency address, personal identity information and an identity verification credential of a client in the client information database; and
record ownership of the at least one unit of CBEM into a transactions database using a client's currency address.

13. The system of claim 11, wherein the system processor comprises a central server.

14. The system of claim 11, wherein the system processor comprises a processor controlled using a smart contract.

15. The system of claim 11, wherein the system processor comprises a central server and a processor controlled by a smart contract.

16. The system of claim 11, wherein the system processor monitors clients' transactions for suspicious transactions, and wherein the at least one criterion is a criterion indicative of at least one of a financial crime risk, a terror funding risk, a transaction in violation of a government sanctions list risk, and a transaction laundering risk, wherein the permissioned transaction network can be modified to reject any transactions that do not the meet the central transaction criteria stored in one of the system processor, and wherein the transaction criteria are defined by a central governing body to stop suspicious transactions likely to be involved in illegal activities, such as money laundering, and the system processor at least one of stops the permissioned transaction and issues an alert in response to obtaining an indication of a suspicious transaction.

17. The system of claim 12, wherein the system processor, determines and obtains at least one of a transaction related and recipient related risk score, and the at least one criterion relates to the risk score, wherein the risk score is based on at least one of comparison of identity related information of at least one client in the system with a sanctions list, an analysis of at least one client's prior transactions for suspicious activity, an analysis of the permission transaction for suspicious activity, an analysis to identify transaction laundering, and an analysis of a source of the client's CBEM for at least one of risky and illegal sources.

18. The system of claim 12, wherein the risk score is increased in response to at least one of (i) one or more times a client has sent CBEM outside of the client wallet in the compliant network, wherein the system processor monitors when CBEM is received from outside the compliant network or sent to outside the compliant network, and (ii) wherein the system processor obtains data concerning at least one of websites visited by the client by monitoring the client's web browser, and the risk score is based on a risk of fraud, a risk of financial crime and a risk of terrorism related to the websites.

19. The system of claim 12, wherein the system processor monitors permissioned transactions for suspicious activity and obtains at least one of the risk score and data used in determining the risk score from a third-party source.

20. The system of claim 12, wherein the client wallet is a multi-signature wallet and/or a wallet for processing smart contracts.

21. The system of claim 12, wherein the client wallet is a wallet that is stored offline at times other than creating the permissioned transaction.

22. A system of personal identification and verification for monitoring and restricting transactions involving cryptography-based electronic money (CBEM), the system comprising:
a system processor configured to, in order to process client identity registrations, client currency addresses, CBEM transactions:
communicate with a client wallet to generate one or more client's permissioned currency addresses;
approve a request for generation of one or more client's permissioned currency addresses;
communicate with the client wallet to create one or more permissioned transactions;
approve one or more transactions to send a unit of CBEM to a currency address;
examine a transaction using transaction criteria defined by a central governing body and/or client; and
store transaction information in a transactions database (413);
wherein the system further comprises:
one or more permissioned currency addresses;
a permissioned transaction network;
a client information database communicatively coupled to the central server;
a transactions database communicatively coupled to the central server; and
at least one client device provided with a client wallet;
wherein the at least one client device is configured to:
obtain permission from the central server to generate one or more permissioned currency addresses;
obtain permission from the central server to create one or more permissioned transactions to send a unit of CBEM to a receiver's currency address;
create one or more permissioned transaction to send a unit of CBEM to a receiver's currency address by signing the transaction; and
wherein the system processor, in response to receiving a permissioned transaction from the client device, examines the transaction based on the transaction criteria and determines a suspicion level for a permissioned transaction and if the suspicion level is above a predetermined threshold indicating that illegal activity is likely based on predefined rules, the system processor denies the transaction, wherein the suspicion level is determined based at least in part on client information in the client information database, the transactions database, the transaction information relating of the permissioned transaction, the criteria defined by a central governing body, location of the client and location of the recipient, and external sources.

23. The system of claim 22, wherein the criteria defined by the central governing body or client includes criteria related to transaction laundering, and the system processor rejects a transaction upon determining that transaction laundering is likely.

24. The system of claim 22, wherein the criteria defined by the central governing body or client includes criteria related to a source of the CBEM involved in the transaction, and the central server uses inputs from the transaction database and external sources, and wherein the criteria defined by the central governing body or client include criteria related to a sanctions list.

25. The system of claim 22, wherein at least one of (i) the system processor monitors clients for suspicious transactions, and the criteria defined by the central governing body or client include a number of times a client has been involved in suspicious transactions and (ii) the system processor determines whether the client or recipient have accessed websites, and the criteria defined by the central governing body or client include criteria related to a type of website accessed.

26. The system of claim 22, wherein the system processor determines whether the client or recipient have accessed websites, and the criteria defined by the central governing body or client include criteria related to a type of website accessed.

27. A system of personal identification and verification for monitoring and restricting transactions involving cryptography-based electronic money (CBEM), the system comprising:
a central server configured to, in order to process client identity registrations within a financial regulation compliant network, assign client currency addresses, and control CBEM transactions:
register clients within the system including identity information;
communicate with a client wallet to generate one or more client's permissioned currency addresses;
approve a request for generation of one or more client's permissioned currency addresses;
communicate with the client wallet to create one or more permissioned transactions;
approve one or more transactions to send a unit of CBEM to a currency address; and
store transaction information in a transactions database;
the system further comprising:
one or more permissioned currency addresses;
a permissioned transaction network;
a client information database communicatively coupled to the central server;
a transactions database communicatively coupled to the central server; and
at least one client device provided with a client wallet, wherein the client wallet is a first type of client wallet created within the compliant network and is configured to communicate with the central server regarding sending and receiving CBEM and to hold multiple types of CBEMs, and
wherein one of those types of CBEMs is a financial regulation compliant CBEM for use within the permissioned transaction network;
wherein the central server is configured to:
generate and transmit an alert signal to an electronic device in response to at least one of (i) the first type of client wallet sending a CBEM to a second type of client wallet, the second type of client wallet being outside of the financial regulation compliant network; and (ii) the first type of client wallet receiving a CBEM other than the financial regulation compliant CBEM.

28. The system of claim 26, wherein the central server monitors permissioned transactions for suspicious activity, and wherein the central server issues an alert to at least one of a client and a governmental agency when suspicious activity is detected.

29. The system of claim 30, wherein the system processor, in response to receipt of a permissioned transaction from the client wallet, compares the permissioned transaction using transaction criteria defined by a central governing body (501) and/or client (502) with compliance criteria, and at least one of stops the permissioned transaction, holds the permissioned transaction for a predetermined period of time, issues an alert concerning the permissioned transaction or client, and reports the permissioned transaction to the central governing body and/or the client.

30. The system of claim 27, wherein the system processor determines a level of suspicion that a permissioned transaction violates at least one of AML including transaction laundering, KYC, CTF, BSA and FATF compliance, and wherein the level of suspicion is based on an analysis of a number of times a client has sent or received cryptocurrencies from outside of the client wallet in the compliant network.
